(19) United States
(12) Patent Application Publication
(10) Pub. No.: US 2025/0374895 A1
(43) Pub. Date: Dec. 11, 2025

(54) ELECTRONIC BEE SMOKER METHODS AND APPARATUS

(71) Applicant: Technically Beekeeping LLC, Gurnee, IL (US)

(72) Inventors: Michael J. Erpenbeck, Gurnee, IL (US); Michael Francis Gilligan, Milwaukee, WI (US); Anna C. Erpenbeck, Gurnee, IL (US); Jennifer L. Erpenbeck, Gurnee, IL (US); Gregory John Binversie, Grayslake, IL (US); Thomas Robert Arnzen, Fort Wright, KY (US)

(21) Appl. No.: 18/734,695

(22) Filed: Jun. 5, 2024

(51) Int. Cl. A01K 55/00; A01K 29/00

(52) U.S. Cl. CPC A01K 55/00; A01K 29/005

(57) ABSTRACT

Systems, apparatus, articles of manufacture, and methods are disclosed for an electronic bee smoker. An example hand-held apparatus for generating a stream of smoke comprises a hand grip including an activation switch, the activation switch to initiate production of smoke, a vessel to contain smoke generating materials, a heating element to receive the smoke generating materials from the vessel, a fan to move air past the heating element, the air to move in a direction away from of the hand grip, and a battery to provide power to the fan and the heating element.

### FIELD OF THE DISCLOSURE

This disclosure relates generally to beehives and, more particularly, to electronic bee smoker methods and apparatus.

### BACKGROUND

Historically, smoke from burning organic material has been used to calm bees when inspecting beehives or harvesting honey. The smoke lessens defensive reactions in bees, particularly when a beekeeper accidentally injures a bee while interacting with the beehive. A smoker is a tool used by beekeepers to generate smoke and direct it towards a target location, typically the beehive or other congregation point of a colony of bees.

### BRIEF DESCRIPTION OF THE DRAWINGS

FIG. 1 is a block diagram of an example environment in which an example electronic bee smoker operates in communication with an example server to inspect an example beehive.

FIGS. 2A-2E show the example electronic bee smoker of FIG. 1 in various orientations.

FIGS. 3A and 3B show the example electronic bee smoker of FIGS. 2A-2E with portions of the example housing removed to show example internal components of the electronic bee smoker.

FIGS. 4A and 4B show example vessels that contain example smoker fuel that can be used with the example electronic bee smoker of FIGS. 2A-2E.

FIGS. 5A-5C show an example mounting system that can be used with the example electronic bee smoker of FIGS. 2A-2E.

FIGS. 6A-6C show an example electronic bee smoker including an example rotating handle.

FIG. 7 shows the example electronic bee smoker of FIGS. 2A-2E with an example emergency button.

FIGS. 8A and 8B show the example electronic bee smoker of FIGS. 2A-2E with an example sensor unit.

FIGS. 9A and 9B show the example sensor unit of FIGS. 8A and 8B.

FIG. 10 is a block diagram of an example implementation of the electronic bee smoker and the server of FIG. 1.

FIG. 11 is a flowchart representative of an example method to inspect beehives with an electronic bee smoker.

FIGS. 12-15 are flowcharts representative of example machine readable instructions and/or example operations that may be executed, instantiated, and/or performed by example programmable circuitry to implement the electronic bee smoker and server of FIG. 10.

FIG. 16 is a block diagram of an example processing platform including programmable circuitry structured to execute, instantiate, and/or perform the example machine readable instructions and/or perform the example operations of FIGS. 12, 13, 14, and/or 15 to implement electronic bee smoker and server of FIG. 10.

FIG. 17 is a block diagram of an example software/firmware/instructions distribution platform (e.g., one or more servers) to distribute software, instructions, and/or firmware (e.g., corresponding to the example machine readable instructions of FIGS. 12, 13, 14, and/or 15) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Known bee smokers typically produce smoke (e.g., a combustion derived aerosol) from burning organic material. A hand operated bellows is used to push smoke through a nozzle towards a target. Known bee smokers are filled with combustible fuel and ignited to produce smoke. Once lit, the ignited fuel requires repeated adjustment to maintain an appropriate temperature and amount of smoke. If the bee smoker is too hot, the smoke may injure bees or the beekeeper. If the bee smoker grows too cold, the bee smoker will not produce enough smoke to effectively calm bees or the fuel will extinguish. Thus, a beekeeper must spend time preparing the bee smoker for use, maintain a consistent heat in the bee smoker during operation, and safely extinguish and store the heated bee smoker between uses.

Example electronic bee smoker apparatus and methods disclosed herein produce aerosols using electronic heating elements. In this way, smoke (e.g., aerosol) can be provided to beehives on demand without needing to start and tend to a fire. Example electronic bee smokers disclosed herein include a hand grip with an activation trigger that allows the electronic bee smokers to be directed and activated with a single hand. Known combustion-based bee smokers become worn after repeated use due to high temperatures degrading the metal components of the bee smokers, requiring replacement of the entire bee smoker. Example electronic bee smokers described herein include replaceable vessels and heating elements for aerosol generation.

Example electronic bee smoker apparatus and methods disclosed herein include sensors to collect data from a beehive. These sensors allow beekeepers to identify a beehive and collect data from the beehive while applying smoke (e.g., an aerosol) to calm the bees. Example data collected can include the location of the beehive, visual data of the beehive, and audio data of the beehive. As smoking the beehive is a part of inspecting the beehive, example electronic bee smokers described herein help improve the efficiency of beekeepers, especially when a large number of beehives need to be monitored and inspected. Mobile beehives, such as beehives used for seasonal agricultural pollination and migratory beekeeping, present a challenge as beehives must be identified and tracked across varying locations. Example electronic bee smokers described herein help to automate the identification of beehives, facilitating the tracking and inspection of mobile beehives.

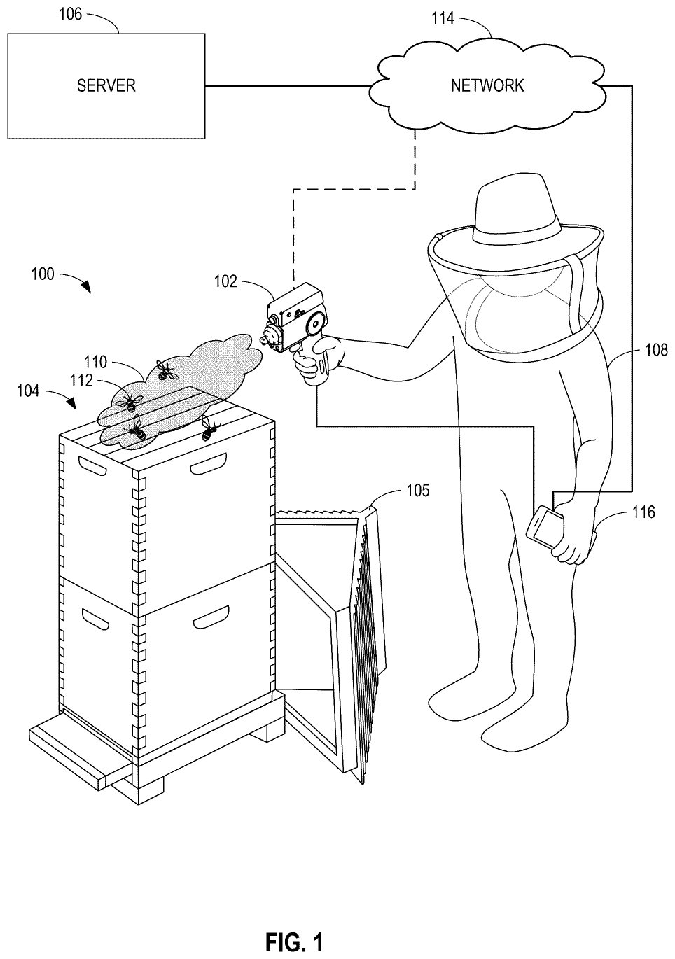

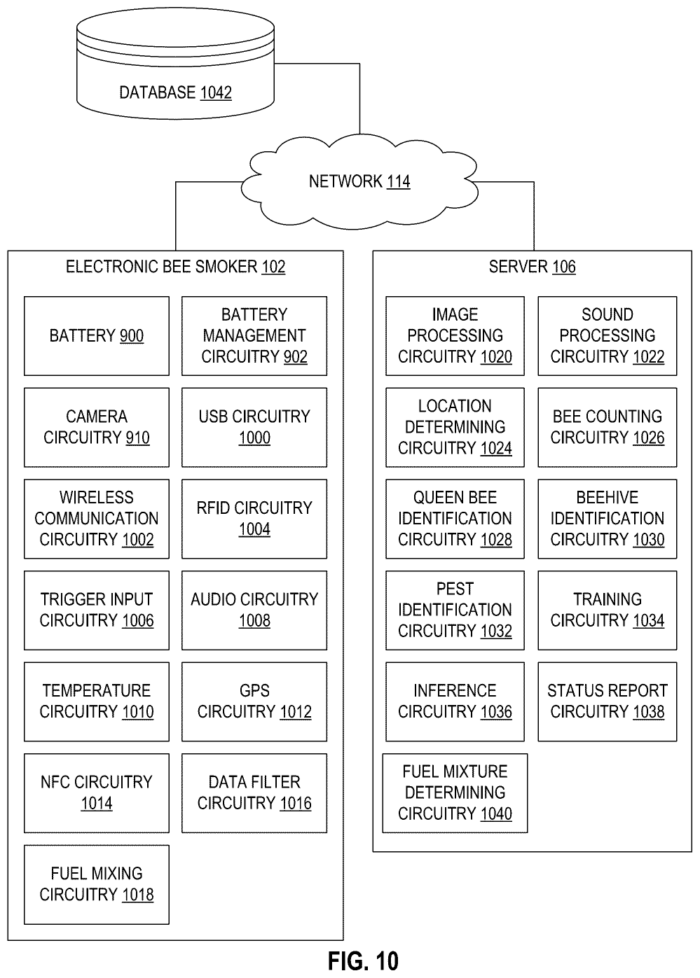

FIG. 1 is a block diagram of an example environment 100 in which an example electronic bee smoker 102 operates in communication with an example server 106 to inspect an example beehive 104. A beekeeper 108 uses the electronic bee smoker 102 to blow an example aerosol 110 (e.g., a smoke, a vapor, etc.) towards the beehive 104 while an example outer cover 105 is removed. The aerosol 110 calms bees 112, lowering defensive behavior (e.g., stinging, swarming, etc.) and allowing for safe inspection of the beehive 104. The electronic bee smoker 102 includes sensors to collect data from the beehive 104 and the bees 112. The electronic bee smoker 102 communicates sensor data to the server 106. In some examples, the electronic bee smoker 102 communicates with an example network 114 directly (e.g., through wireless communication circuitry). In some examples, the electronic bee smoker 102 additionally or alternatively communicates the sensor data with an example wireless device 116 (e.g., a mobile phone, a tablet, etc.) that is in communication with the network 114. In some examples, the server 106 processes the sensor data, as described in further detail in relation to FIG. 10.

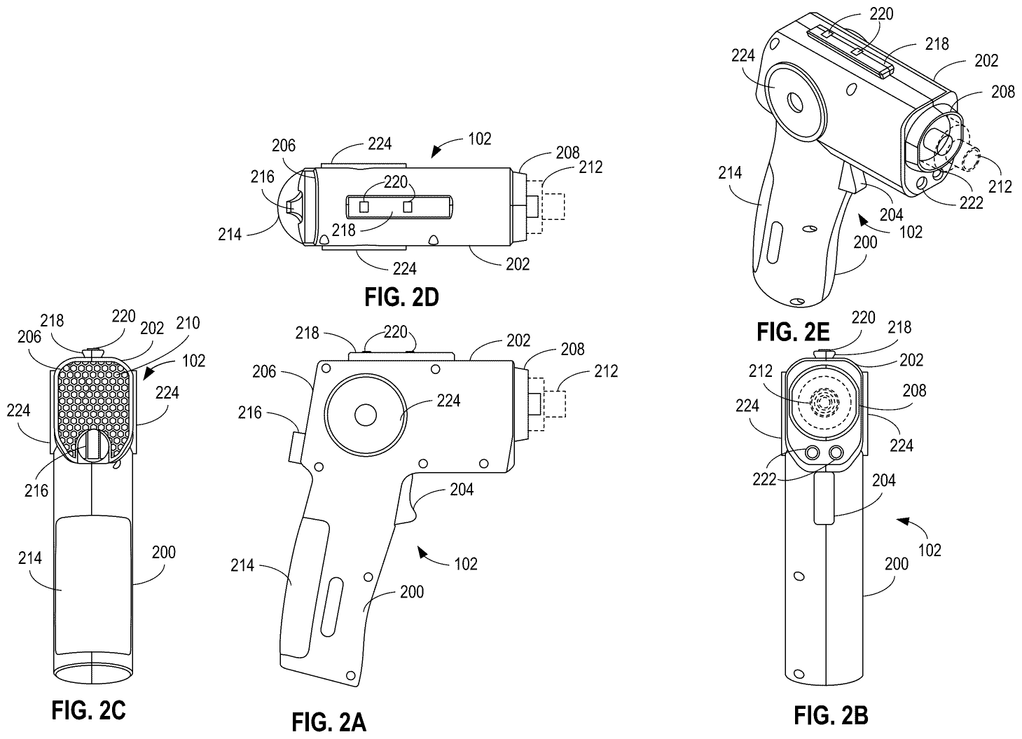

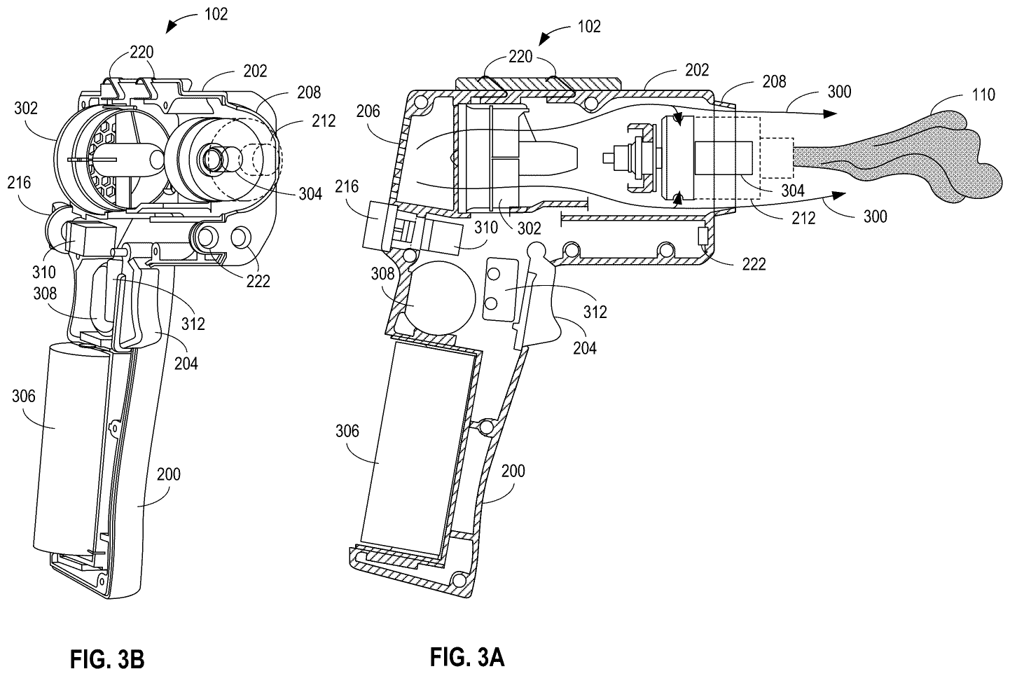

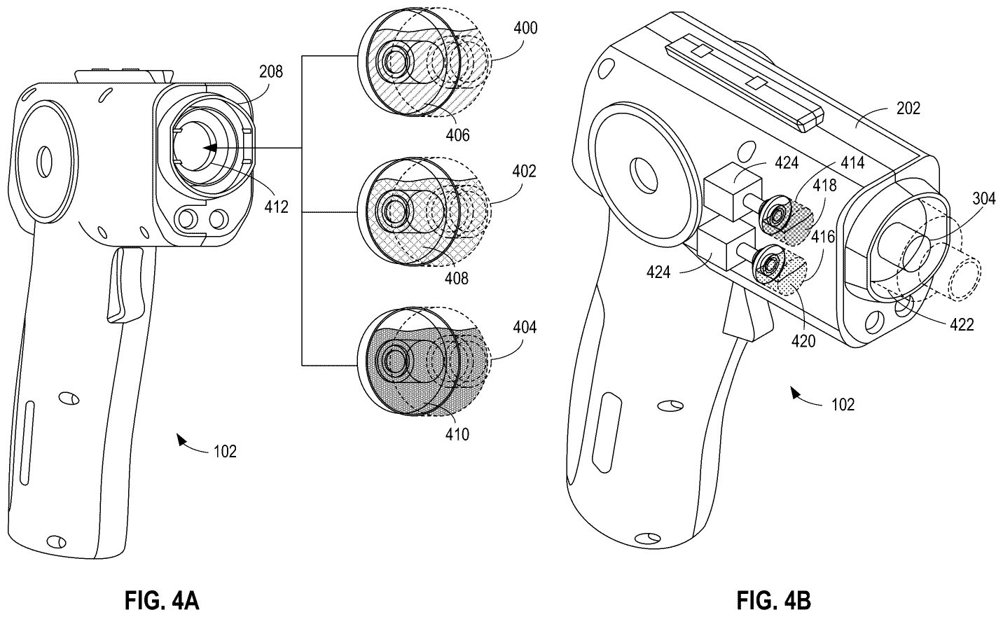

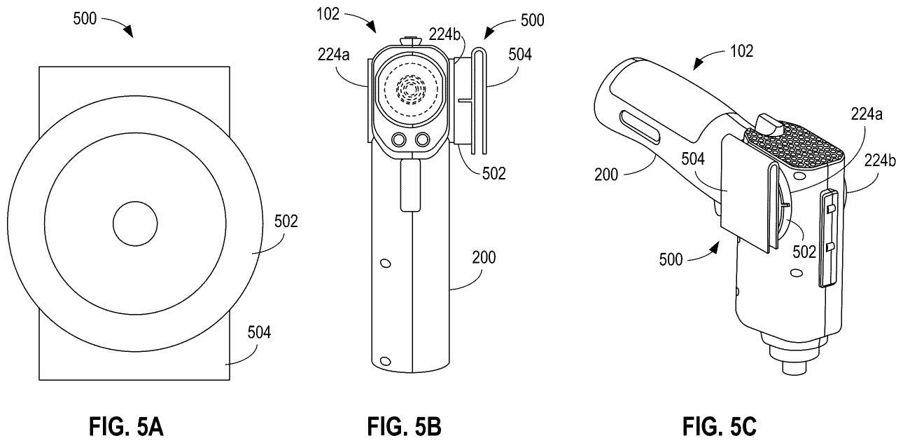

FIGS. 2A-2E show the example electronic bee smoker 102 of FIG. 1 in various orientations. FIG. 2A is a side view of the electronic bee smoker 102. FIG. 2B is a front view of the electronic bee smoker 102. FIG. 2C is a rear view of the electronic bee smoker 102. FIG. 2D is a top view of the electronic bee smoker 102. FIG. 2E is a perspective view of the electronic bee smoker 102. The electronic bee smoker 102 includes an example handle 200 (e.g., a hand grip) to allow the electronic bee smoker 102 to be held by a hand during use. In some examples, the handle 200 extends away from an example housing 202 (e.g., a body of the electronic bee smoker) in a substantially perpendicular direction (e.g., within 20 degrees of perpendicular to an elongate length of the housing 202). The handle 200 includes an example trigger 204 (e.g., activation switch). In some examples, the trigger 204 is located proximate an end of the handle 200 such that a user can rest a finger on the trigger 204 while holding the electronic bee smoker 102 by the handle 200. The electronic bee smoker 102 includes an example inlet 206 and an example nozzle 208. In some examples, the inlet 206 is located on a first end of the housing 202 (e.g., the body) and the nozzle 208 is located on a second end, opposite the first end of the housing 202. Air enters the inlet 206 and exits the nozzle 208. In some examples, the inlet 206 includes an example screen 210 to prevent bees and/or other objects from entering the electronic bee smoker 102. More details regarding the flow of air through the electronic bee smoker 102 is provided below in relation to FIG. 3A. The example electronic bee smoker 102 of FIGS. 2A-2E includes an example vessel 212 disposed in the nozzle 208. In some examples, the nozzle 208 is part of the vessel 212, allowing airflow to enter the inlet 206, flow through the vessel 212, and exit the nozzle 208. The vessel 212 contains fuel for generating aerosols, as discussed in more detail in relation to FIGS. 4A and 4B. In some examples, the vessel 212 includes translucent material (e.g., glass, plastic, etc.) to allow the fuel contained inside the vessel 212 to be viewed from the outside. In other examples, the electronic bee smoker 102 contains multiple vessels containing different fuels and/or additives, as further detailed below in relation to FIG. 4B. In some examples, the electronic bee smoker 102 includes an example removable battery cover 214 to partially house a battery within the electronic bee smoker 102. An example speed control knob 216 (e.g., potentiometer knob) is located on the housing 202 to adjust the speed of air (e.g., the amount of air) entering the electronic bee smoker 102. In some examples, the electronic bee smoker 102 includes an example attachment point 218 (e.g., mounting location) to receive accessories (e.g., a sensor unit, an auxiliary light, etc.). In some examples, the attachment point 218 is located on an exterior surface (e.g., a top surface, a bottom surface, side surface, etc.) of the housing 202. The attachment point 218 includes example electrical contacts 220 (e.g., an electrical interface). In some examples, the electrical contacts 220 transmit a signal to an attached accessory (e.g., a sensor unit). In other examples, the electrical contacts 220 transmit power to an attached accessory. The electronic bee smoker 102 includes example light emitting diodes 222 (LEDs). In some examples, the LEDs 222 are activated (e.g., supplied power) while the trigger 204 is depressed. In some examples, the LEDs 222 remain activated for a set time (e.g., 15 seconds, 30 seconds, 1 minute, etc.) after the trigger 204 is released. In some examples, the LEDs 222 emit light in a direction toward a beehive during use of the electronic bee smoker 102. In some examples, the LEDs 222 emit white light to aid inspection of the beehive. In other examples, the LEDs 222 emit red light to reduce the impact of the LEDs on the bees' vision. In some examples, the LEDs 222 emit ultraviolet light. Ultraviolet light is used to induce fluorescence in bee eggs and larvae so they are easier to identify and inspect. The example electronic bee smoker 102 of FIGS. 2A-2E includes example mounting points 224, which are used to store or otherwise hang the electronic bee smoker 102 when not in use (as discussed in further detail below in relation to FIGS. 5A-5C).

FIGS. 3A and 3B show the example electronic bee smoker 102 of FIGS. 2A-2E with portions of the example housing 202 removed to show example internal components of the electronic bee smoker 102. For clarity, wires and other known electrical connections have been omitted from FIGS. 3A and 3B. However, it should be understood that the electronic bee smoker 102 includes additional electrical components as is known in the art to allow for proper functioning of the electronic bee smoker 102 and the components described herein.

FIG. 3A shows an example airflow path 300 of air as it drawn through the inlet 206 by an example fan 302 (e.g., an airflow generator). In some examples, the airflow path 300 continues past the fan 302 to move inside and around the vessel 212. In this way, the aerosol 110 produced in the vessel 212 is entrained (e.g., captured by an air jet) by the airflow path 300 to form an aerosol jet (e.g., smoke jet, vapor jet, stream of smoke, etc.). The nozzle 208 guides or otherwise directs the airflow path 300 as it exits the housing 202, allowing the resulting aerosol 110 to be directed towards a target (e.g., the beehive 104).

The electronic bee smoker 102 of FIGS. 3A and 3B includes an example heating element 304. The heating element 304 receives fuel (e.g., material used to generate an aerosol, smoke generating materials, aerosol generating substance, aerosol generating compounds, etc.) from the vessel 212 and heats the fuel to generate aerosol (e.g., smoke, vapor, etc.). The fuel stored in the vessel 212 and heated by the heating element 304 is at least one of a liquid fuel, a wax fuel, and/or a combustible organic material (e.g., plant materials, animal materials, etc.). In some examples, the heating element 304 is disposed in the vessel 212. In some examples, the vessel 212 and the heating element 304 are combined to form an aerosol generator. In some examples, the aerosol generator uses alternative methods to generate aerosol (e.g., ultrasonic vibrations, spray nozzles, etc.).

The example electronic bee smoker 102 of FIGS. 3A and 3B includes an example power source 306 (e.g., battery, rechargeable battery, voltage source, etc.) provides power to the fan 302 and the heating element 304. In some examples, an example power conditioner 308 modifies the power provided by the power source 306 (e.g., changes an amount of power, a voltage of the power, etc.) so that it is usable by the heating element 304. In some examples, an example potentiometer 310, receiving input from the speed control knob 216, is used to adjust a power provided to the fan 302, thereby increasing or decreasing a rotational speed of the fan 302. In some examples, the potentiometer 310 includes a switch that disconnects the power source 306 when the potentiometer 310 is rotated to a switch position (e.g., fully rotated, rotated to a fixed stopping position, etc.). In this way, the electronic bee smoker 102 cannot be activated while the potentiometer 310 is rotated to the switch position. In some examples, the trigger 204 is coupled to an example electronic switch 312 that initiates a power transfer from the power source 306 to the fan 302 and/or heating element 304 to initiate production of smoke (e.g., aerosol). In some examples, the electronic switch 312 is a momentary switch that only transfers power when depressed or otherwise actuated. In some examples the trigger 204 may send power and/or an electrical signal to the electrical contacts 220. In some examples the trigger 204 may send power and/or electrical signals at different amounts of travel (e.g., extent of being pressed, total depression, etc.). For example, the trigger 204 can supply power and/or electrical signals to the LEDs 222 and the electrical contacts 220 when the trigger 204 is pressed halfway, and additionally supply power to the fan 302 and heating element 304 when the trigger 204 is pressed flush to the handle.

FIG. 4A shows example vessels 400, 402, 404 that contain example smoker fuel 406, 408, 410 that can be used with the example electronic bee smoker 102 of FIGS. 2A-2E. The vessels 400, 402, 404 removably couple to the electronic bee smoker 102. The smoker fuel 406, 408, 410 can contain different additives to augment the function of the electronic bee smoker 102. For example, the vessel 400 can contain the smoker fuel 406 to produce smoke to calm bees, the vessel 402 can contain the smoker fuel 408 with additional calming additives (e.g., hops oil) if bees show signs of aggression, and the vessel 404 can contain the smoker fuel 410 with pest repelling additives (e.g., thyme oil, wintergreen oil, etc.). In some examples, the vessels 400, 402, 404 couple to an example nest 412 within the nozzle 208 with a permanent magnet. In this way, the electronic bee smoker 102 can be easily refilled with fuel when the vessel is empty and/or a different type of smoker fuel may be placed in the electronic bee smoker 102 without needing to add or remove fuel from a vessel.

FIG. 4B shows example vessels 414, 416 that provide example smoker fuels and/or additives 418, 420 to an example mixing chamber 422 that can be used with the example electronic bee smoker 102 of FIGS. 2A-2E. Pumps 424 (e.g., peristaltic pumps) move the fuels and/or additives 418, 420 from the vessels 414, 416 to the mixing chamber 422 to create the fuel mixture (e.g., smoke generating materials) for generating aerosols. For example, the mixing chamber 422 can receive smoker fuel 418 from the vessel 414 and a calming additive 420 (e.g., hops oil) from the vessel 416, thus creating a calming smoker fuel within the mixing chamber 422. The pumps 424 provide a predetermined amount of smoker fuels and/or additives 418, 420 (e.g., a fuel mixture recipe) to the mixing chamber 422 to create the fuel mixture. The fuel mixture is presented to an example heating element 304 to generate an aerosol. In some examples, the electronic bee smoker 102 includes additional vessels (e.g., four vessels, five vessels, eight vessels, etc.), each vessel containing smoker fuels and/or additives, and additional corresponding pumps to move the smoker fuels and/or additives to the mixing chamber 422. In this way, the electronic bee smoker 102 can generate different aerosols based on different fuel mixture recipes. In some examples, the vessels 414, 416 and the pumps 424 are disposed outside of the housing 202. In other examples, the vessels 414, 416 and the pumps 424 are disposed inside of the housing 202. In some examples, the vessels 414, 416 and the pumps 424 are integrated (e.g., coupled to) the mixing chamber 422.

FIGS. 5A-5C show an example mounting system 500 that can be used with the example electronic bee smoker 102 of FIGS. 2A-2E. The mounting system 500 is removably coupled to the electronic bee smoker 102. In this way, the electronic bee smoker 102 can be safely stored and/or held by the mounting system 500 while not in use. FIG. 5A shows the example mounting system 500 decoupled from the electronic bee smoker 102. The mounting system 500 includes a receiving portion 502 (e.g., a mount) to receive and hold the electronic bee smoker 102. In some examples, the mounting system 500 includes a clip 504. The clip 504 allows the mounting system 500 to attach to a beekeeper (e.g., to an article of clothing, to a belt, etc.). In this way, the electronic bee smoker 102 can be stored on the mounting system 500 until the beekeeper is ready to use the electronic bee smoker 102, removed from the mounting system 500 for use, and returned to the mounting system 500 once use is completed. In other examples, the mounting system 500 is coupled to a beekeeper in a different way (e.g., sewn to an article of clothing, etc.).

FIG. 5B illustrates the electronic bee smoker 102 and the example mounting system 500 coupled together. The electronic bee smoker 102 includes example first and second mounting points 224a, 224b (e.g., fixing portions) to couple with the receiving portion 502. FIG. 5B shows the mounting system 500 coupled to the second mounting point 224b on a first side of the electronic bee smoker 102. FIG. 5C shows the mounting system 500 coupled to the first mounting point 224a on a second side of the electronic bee smoker 102. In this way, the receiving portion 502 can be selectively coupled to the first mounting point 224a or the second mounting point 224b. FIGS. 5B and 5C show the electronic bee smoker 102 coupled to the mounting system 500 in different orientations relative to the clip 504. The electronic bee smoker 102 can couple to the mounting system 500 in a variety of rotational positions to best suit the needs and/or preferences of a beekeeper. In some examples, the mounting system 500 is configured to orient the electronic bee smoker 102 in a specific direction relative to the mounting system 500 (e.g., handle 200 down, handle 200 parallel to the ground, etc.). In some examples, the mounting system 500 is configured to orient the electronic bee smoker 102 in a plurality of discrete directions relative to the mounting system 500 that can be freely selected by the beekeeper. In some examples, the mounting system 500 is configured to decouple from the electronic bee smoker 102 when the electronic bee smoker 102 is at a specific orientation relative to the mounting system 500 and remain coupled to the electronic bee smoker 102 at all other orientations. In some examples, the mounting system uses permanent magnets or a combination of permanent magnets and ferromagnetic materials to couple the receiving portion 502 to one of the mounting points 224a, 224b. In some examples, the mounting points 224a, 224b and the receiving portion 502 include guide features (e.g., a protrusion and a matched recess) to position the mounting points 224a, 224b relative to the receiving portion 502 during coupling. The mounting points 224a, 224b are shown in example positions on the electronic bee smoker 102. In other examples, the mounting points 224a, 224b can have different positions on the electronic bee smoker 102 (e.g., on the handle 200).

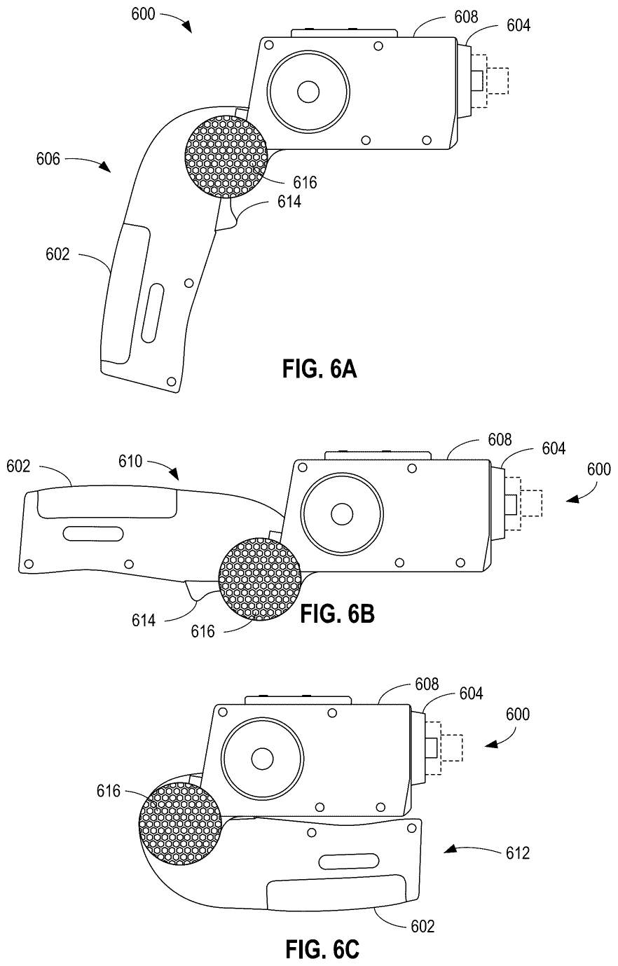

FIGS. 6A-6C show an example electronic bee smoker 600 including an example rotating handle 602. The rotating handle 602 allows a beekeeper to adjust the position of the rotating handle 602 relative to an example nozzle 604. In other words, the rotating handle 602 allows the beekeeper to maintain a desired hand position while directing smoke (e.g., aerosol) towards a target (e.g., a beehive). FIG. 6A shows the rotating handle 602 in a substantially perpendicular position 606 relative to an example housing 608 (e.g., within 20 degrees of perpendicular to a longitudinal axis of the housing 608). FIG. 6B shows the rotating handle 602 in a substantially parallel position 610 relative to the housing 608 (e.g., within 20 degrees of parallel to a longitudinal axis of the housing 608). FIG. 6C shows the rotating handle 602 in a stowed position 612 (e.g., positioned so an edge of the rotating handle 602 is resting along the housing 608). The electronic bee smoker 600 includes an example trigger 614. The trigger 614 is hidden when the rotating handle 602 is in the stowed position 612. The trigger 614 can be used to activate the electronic bee smoker 600 when the rotating handle 602 is in a position to expose the trigger 614 (e.g., the perpendicular position 606, the parallel position 610). When the rotating handle is in the stowed position 612, the trigger 614 is hidden and cannot be used to activate the electronic bee smoker 600. In some examples, the electronic bee smoker 600 includes an example fan 616 located between the rotating handle 602 and the housing 608.

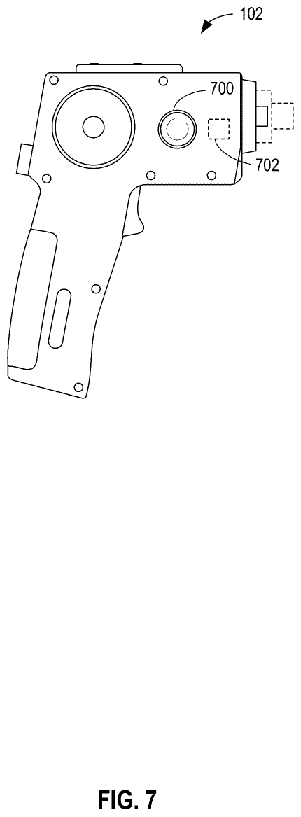

FIG. 7 shows the example electronic bee smoker 102 of FIGS. 2A-2E with an example emergency button 700. The emergency button 700 can be used during an inspection in response to aggressive bees. In some examples, the emergency button 700 activates an example sound generating device 702 in the electronic bee smoker 102. The sound generating device 702 emits ultrasonic frequency sounds to repel the aggressive bees. In some examples, the sound generating device 702 produces a loud sound (e.g., a sound of more than 80 decibels) to temporarily disorient (e.g., stun, immobilize, etc.) the bees. In some examples, the sound generating device generates a sound to mimic a signal from the queen bee (e.g., tooting, piping, a sound pulse between 300 hertz and 1000 hertz and between 107 decibels and 120 decibels, etc.) that causes bees to stop moving (e.g., freeze). In some examples, the emergency button 700 can be a button, a switch, or any other suitable device to send an electric signal.

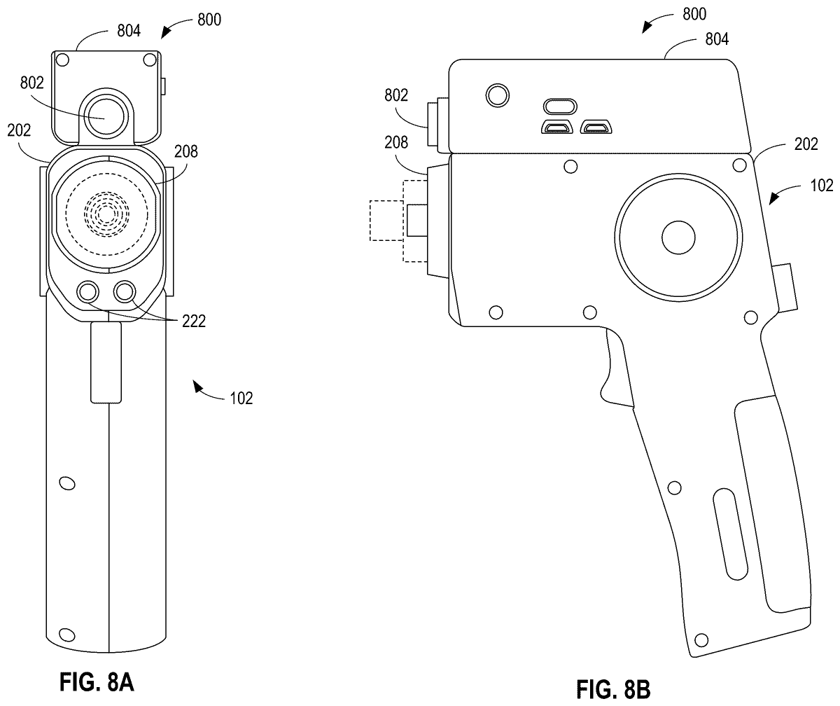

FIGS. 8A and 8B show the example electronic bee smoker 102 of FIGS. 2A-2E with an example sensor unit 800. FIG. 8A is a front view of the electronic bee smoker 102. FIG. 8B is a side view of the electronic bee smoker 102. The sensor unit 800 contains sensors to capture data from a beehive while the electronic bee smoker 102 is being used, as further detailed below in relation to FIG. 10. In some examples, the sensor unit 800 receives an electrical signal from the electronic bee smoker 102 via the electrical contacts 220 (not shown). The sensor unit 800 includes an example camera 802 (e.g., a digital camera) to capture visual data (e.g., images, videos, etc.). FIG. 8A shows the camera 802 (e.g., the lens of the camera 802), the nozzle 208, and the LEDs 222 pointing in the same direction. In other words, the camera 802 captures visual data from a working end (e.g., in a direction parallel to the nozzle 208) of the electronic bee smoker 102. In some examples, the sensor unit 800 couples to the electronic bee smoker 102 via the attachment point 218 (not shown). The sensor unit 800 includes an example housing 804 to house the camera 802 and other sensors. In some examples, the housing 804 includes a mounting location to receive the attachment point 218 (not shown), thus removably (e.g., detachably) coupling the sensor unit 800 to the electronic bee smoker 102. In other examples, the sensor unit 800 can be coupled to the electronic bee smoker 102 via other suitable means and/or at other locations on the electronic bee smoker 102. In some examples, the sensor unit 800 couples to different beekeeping tools (e.g., a glove, a hat, a beekeeping suit, etc.). In some examples, the sensor unit 800 is not a separate unit, but rather integrated within the housing 202 of the electronic bee smoker 102.

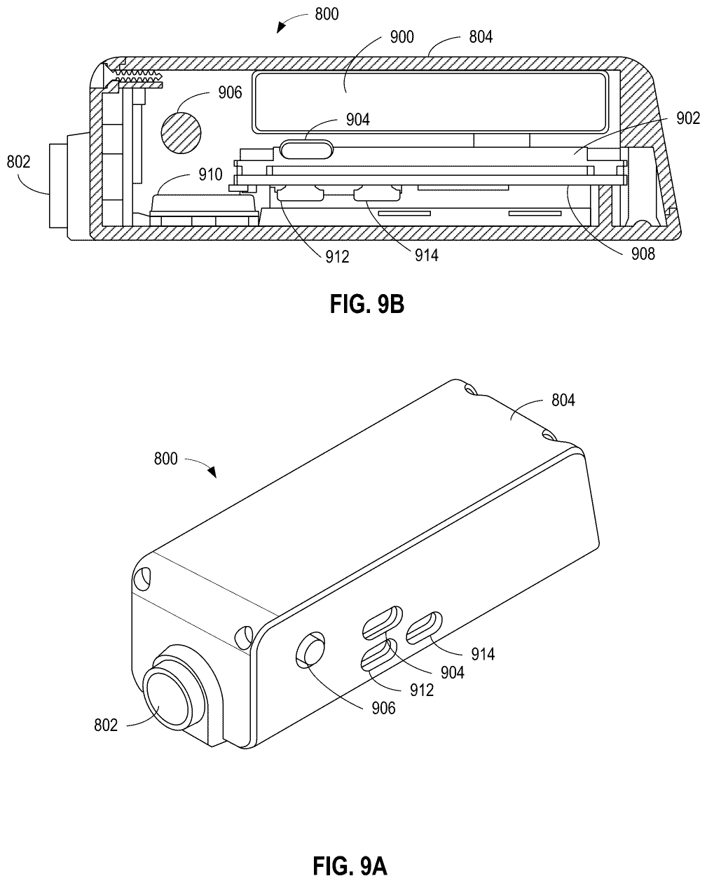

FIGS. 9A and 9B show the example sensor unit 800 of FIGS. 8A and 8B. FIG. 9A is a perspective view of the sensor unit 800. FIG. 9B shows the sensor unit 800 with a portion of the housing 804 cross-sectioned to show the interior of the sensor unit 800. For clarity, wires and other known electrical connections have been omitted from FIG. 9B. The sensor unit 800 contains an example battery 900 (e.g., power source) to power circuitry and sensors contained in the sensor unit 800. The sensor unit 800 includes example battery management circuitry 902 to control the battery 900, distribute power to sensors, and receive external power through an example external power connector 904. The external power connector 904 can be any suitable connector to receive power (e.g., a USB port, a coaxial power port, etc.) positioned in an opening of the housing 804. In some examples, the sensor unit 800 includes a power switch 906 to send electrical signals to the battery management circuitry 902. In some examples, the power switch 906 sends a signal to the battery management circuitry 902 to apply or remove power to the sensor unit 800. In other examples, the power switch 906 sends a signal to activate the sensor unit 800 to collect data. In other examples, the power switch 906 is one of a plurality of switches, and each of the plurality switches sends signals to the sensor unit 800. The sensor unit 800 includes various sensors at least partially contained within the housing 804 (e.g., a microphone, a digital camera, a global positioning system receiver, a temperature sensor, etc.). An example sensor circuitry 908 communicates with the sensors to receive or otherwise obtain data from the sensors. In some examples, as further detailed below in relation to FIG. 10, sensors can be integrated in the sensor circuitry 908. In other examples, separate sensor circuitry can be in communication with the sensor circuitry 908. For example, example camera circuitry 910 communicates with the camera 802 and the sensor circuitry 908, providing visual data from the camera 802 to the sensor circuitry 908. In some examples the sensor circuitry 908 includes an example communication port 912 (e.g., a serial port, a universal serial bus, etc.). In some examples, the sensor circuitry 908 includes an examples external power port 914 to receive power from an external power supply.

FIG. 10 is a block diagram of an example implementation of the electronic bee smoker 102 and the server 106 of FIG. 1 to inspect a beehive. In some examples, the electronic bee smoker 102 of FIG. 10 includes a sensor unit 800, and some or all of the circuitry described below in connection to the electronic bee smoker 102 resides in the sensor unit 800 to function with, but independent of, the electronic bee smoker 102. The electronic bee smoker 102 and the server 106 of FIG. 10 may be instantiated (e.g., creating an instance of, bring into being for any length of time, materialize, implement, etc.) by programmable circuitry such as a Central Processor Unit (CPU) executing first instructions. Additionally or alternatively, the electronic bee smoker 102 and the server 106 of FIG. 10 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 10 may, thus, be instantiated at the same or different times. Some or all of the circuitry of FIG. 10 may be instantiated, for example, in one or more threads executing concurrently on hardware and/or in series on hardware. Moreover, in some examples, some or all of the circuitry of FIG. 10 may be implemented by microprocessor circuitry executing instructions and/or FPGA circuitry performing operations to implement one or more virtual machines and/or containers.

The electronic bee smoker 102 of FIG. 10 includes circuitry to collect and process data from sensor circuitry. The electronic bee smoker and/or the sensor unit 800 can include one or more of an example battery 900, example battery management circuitry 902, example universal serial bus (USB) circuitry 1000, example wireless communication circuitry 1002, example radio frequency identification (RFID) circuitry 1004, example trigger input circuitry 1006, example camera circuitry 910, example audio circuitry 1008, example temperature circuitry 1010, example global positioning system (GPS) circuitry 1012, example near-field communication (NFC) circuitry 1014, example data filter circuitry 1016, and example fuel mixing circuitry 1018.

The example server 106 of FIG. 10 includes circuitry to analyze sensor data and generate status data corresponding to a status of the beehive. The server 106 can include one or more of example image processing circuitry 1020, example sound processing circuitry 1022, example location determining circuitry 1024, example bee counting circuitry 1026, example queen bee identification circuitry 1028, example beehive identification circuitry 1030, example pest identification circuitry 1032, example training circuitry 1034, example inference circuitry 1036, example status report circuitry 1038, and example fuel mixture determining circuitry 1040.

The server 106 and the electronic bee smoker 102 of FIG. 10 are in communication with an example network 114. An example database 1042 stores sensor data and/or status data generated by the electronic bee smoker 102 and the server 106 as historic sensor data and/or historic status data. In this way, data is collected, analyzed, and stored between the server 106, the electronic bee smoker 102, and the database 1042.

The example battery management circuitry 902 controls power distributed from the battery 900 as well as the power entering the battery 900. In some examples, the battery management circuitry 902 conditions a power (e.g., modifies the power to an appropriate voltage) to be supplied to one or more sensors. In some examples, the battery management circuitry 902 controls charging of the battery 900 via an external power supply (e.g., 5-volt power provided to the external power connector 904). In some examples, the battery management circuitry 902 is instantiated by programmable circuitry executing battery management instructions.

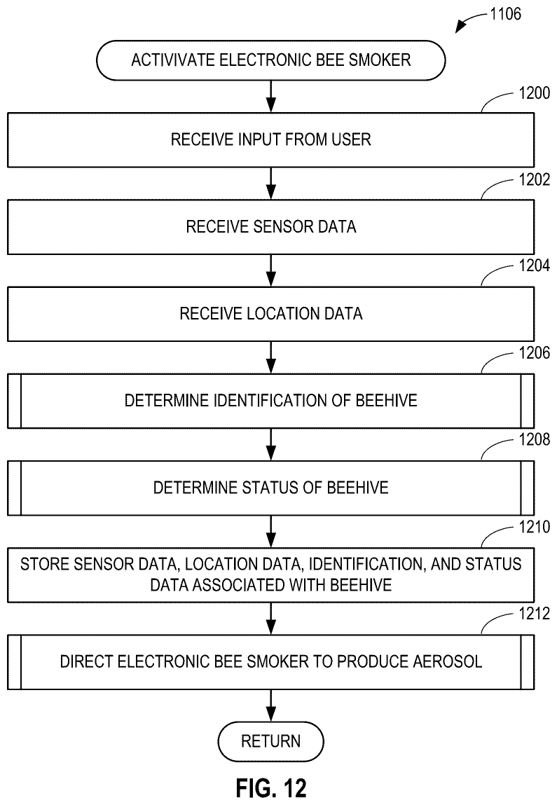

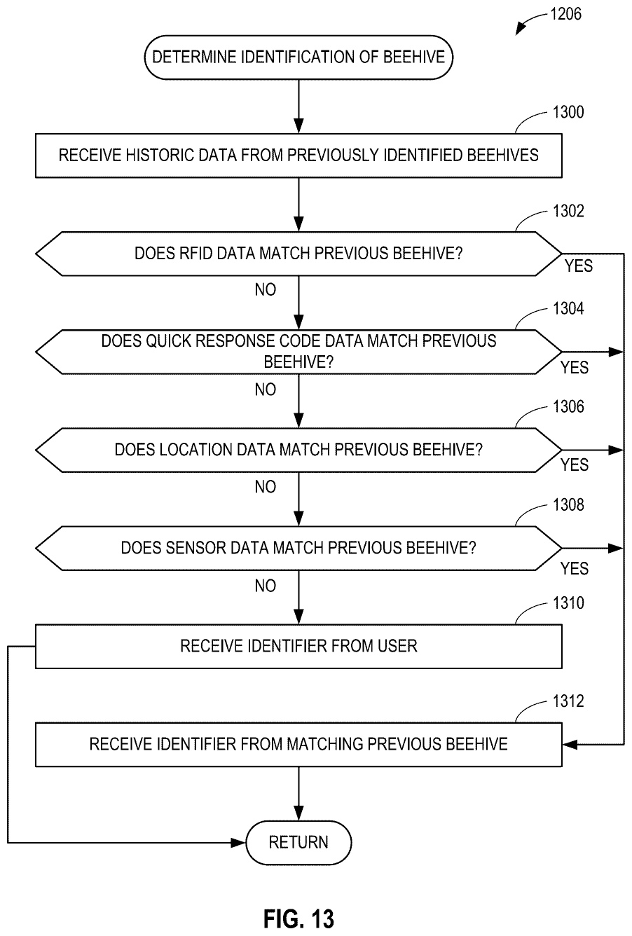

The example camera circuitry 910 converts visual data (e.g., camera data) received from an example optical sensor (e.g., the camera 802) into digital image data and/or digital video data for later use. In some examples, the image data contains a barcode (e.g., a barcode, a two-dimensional matrix barcode, quick-response code, etc.) that is decoded by the camera circuitry 910. For example, the camera circuitry 910 detects the presence of a quick-response code (QR code) and decodes the QR code into usable data (e.g., an identifier of a beehive). In some examples, the camera circuitry 910 is instantiated by programmable circuitry executing camera instructions and/or configured to perform operations such as those represented by the flowcharts of FIGS. 12, 13, and/or 14.

The example USB circuitry 1000 transmits data from the electronic bee smoker 102 to an external device. In some examples, the USB circuitry 1000 transmits data collected by the sensors to an external storage device. In other examples, the USB circuitry 1000 transmits the data collected by the sensors to a separate user device (e.g., a personal computer, a mobile device, etc.). In some examples, the USB circuitry 1000 enables wired communication between the electronic bee smoker 102 and the network 114. Additionally or alternatively, the example wireless communication circuitry 1002 allows wireless communication between the electronic bee smoker 102 and the network 114.

The example RFID circuitry 1004 receives data from an example RFID reader. The RFID reader reads RFID data from an example RFID tag placed on or near a beehive. In some examples, the RFID data correlates to identification data (e.g., an identifier) of the beehive or subcomponent of the beehive (e.g., a frame of the beehive). In other examples, the RFID data correlates to a status of the beehive. In some examples, the RFID circuitry 1004 includes NFC circuitry 1014 to collect short range RFID data and/or communicate with NFC devices. In some examples, the RFID circuitry 1004 is instantiated by programmable circuitry executing RFID instructions and/or configured to perform operations such as those represented by the flowcharts of FIGS. 12 and/or 13.

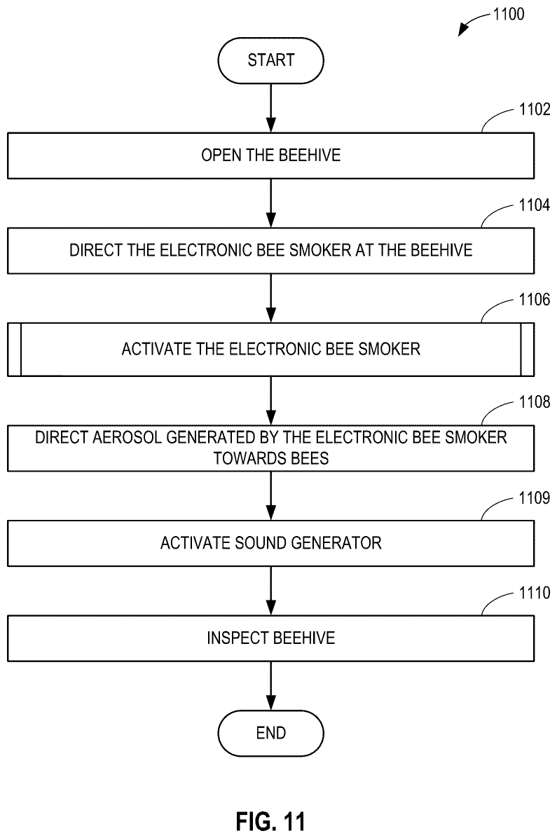

The example trigger input circuitry 1006 receives user signals from the electronic bee smoker 102. In some examples, the trigger input circuitry 1006 receives signals (e.g., momentary electrical signals) from an activation trigger (e.g., the trigger 204). In other examples, the trigger input circuitry 1006 receives user input through a different hardware input device (e.g., a button, a switch, etc.) located on the electronic bee smoker 102. In some examples, the trigger input circuitry 1006 activates or deactivates components of the electronic bee smoker 102 based on the presence of a user signal (e.g., the trigger 204 being depressed). In some examples, the trigger input circuitry 1006 determines an extent of a user signal (e.g., a half pressed trigger, a fully pressed trigger, etc.) and activates or deactivates components based on the extent of the user signal. In other examples, the trigger input circuitry 1006 activates or deactivates components of the electronic bee smoker 102 based on a threshold number of user signals within a threshold amount of time (e.g., the trigger 204 being depressed three times within two seconds). In some examples, the trigger input circuitry 1006 is instantiated by programmable circuitry executing user input instructions and/or configured to perform operations such as those represented by the flowcharts of FIGS. 11 and/or 12.

The example audio circuitry 1008 generates audio data from sounds received by an example audio sensor (e.g., a microphone). In some examples, the audio circuitry 1008 generates uncompressed digital audio files. In other examples, the audio circuitry 1008 generates compressed audio files. In some examples the audio circuitry 1008 selectively records specific frequencies of sounds (e.g., sound frequencies correlating to bee activity). In some examples, the audio circuitry 1008 is instantiated by programmable circuitry executing audio instructions and/or configured to perform operations such as those represented by the flowcharts of FIGS. 12, 13, and/or 14.

The example temperature circuitry 1010 generates temperature data from an example thermal sensor (e.g., a thermistor, infrared thermometer, thermographic camera, etc.). In some examples, the temperature circuitry 1010 correlates temperature data with a status and/or health of a beehive. In some examples, the temperature circuitry 1010 is instantiated by programmable circuitry executing temperature instructions and/or configured to perform operations such as those represented by the flowcharts of FIGS. 12, 13, and/or 14.

The example GPS circuitry 1012 receives GPS data from GPS satellites and generates location data (e.g., latitude, longitude, elevation, etc.). In some examples, the location data includes time data and date data corresponding to a time and a date that the location data was collected. In some examples, the location data generated by the GPS circuitry 1012 is used to determine weather data (e.g., ambient temperature, cloud cover, precipitation, etc.) corresponding to the time and location of the beehive inspection. In some examples, the GPS circuitry 1012 is instantiated by programmable circuitry executing GPS instructions and/or configured to perform operations such as those represented by the flowcharts of FIGS. 12, 13, and/or 14.

The example data filter circuitry 1016 filters data received by sensors in the electronic bee smoker 102 before the data is analyzed. The data filter circuitry 1016 determines if sensors are working properly and/or if data is usable (e.g., within expected parameters). For example, the data filter circuitry 1016 removes image data received from the camera circuitry 910 that is too dark or too bright to be analyzed. In some examples, the data filter circuitry 1016 analyzes image data to determine if the image is likely to contain bees (e.g., includes bee colors, includes bee shapes, etc.). In some examples, the data filter circuitry 1016 removes audio data that is outside of a loudness range and/or a frequency range. In some examples, the data filter circuitry 1016 is instantiated by programmable circuitry executing data filter instructions and/or configured to perform operations such as those represented by the flowcharts of FIGS. 12, 13, and/or 14.

The example fuel mixing circuitry 1018 receives a fuel mixture recipe (e.g., fuel mixture recommendation) from the fuel mixture determining circuitry 1040 and directs the electronic bee smoker 102 to generate a fuel mixture (e.g., fuel solution) according to the fuel mixture recipe. In some examples, the fuel mixing circuitry 1018 directs one or more fluid pumps (e.g., peristaltic pumps) to combine one or more volumes of one or more smoke generating fuels to generate the fuel mixture. In some examples, the fuel mixing circuitry 1018 directs the fluid pumps to combine a smoke generating fuel with an additive (e.g., hops oil, thyme oil, etc.). In some examples, the fuel mixing circuitry 1018 is instantiated by programmable circuitry executing fuel mixing instructions and/or configured to perform operations such as those represented by the flowcharts of FIG. 12 and/or 15.

The example image processing circuitry 1020 processes visual data from the camera circuitry 910. The image processing circuitry 1020 prepares the visual data for use with other circuitry such as the bee counting circuitry 1026, the queen bee identification circuitry 1028, the beehive identification circuitry 1030, the pest identification circuitry 1032, the training circuitry 1034, and/or the inference circuitry 1036. For example, the image processing circuitry 1020 can compress image data, change a format of image data, crop image data, and/or adjust an image (e.g., modify contrast, modify color saturation, remove specific colors, etc.) in preparation for further processing. In some examples, the image processing circuitry 1020 prepares visual data to be used with training circuitry 1034 and inference circuitry 1036 to generate an artificial intelligence model to identify and count objects within the visual data. In some examples, the image processing circuitry 1020 decodes QR codes within the visual data. In some examples, the image processing circuitry 1020 is instantiated by programmable circuitry executing imaging processing instructions and/or configured to perform operations such as those represented by the flowcharts of FIGS. 12, 13, and/or 14.

The example sound processing circuitry 1022 processes audio data received from audio sensors (e.g., microphones). The sound processing circuitry 1022 prepares audio data for use with other circuitry such as the queen bee identification circuitry 1028, the pest identification circuitry 1032, the beehive identification circuitry 1030, and/or the status report circuitry 1038 to determine a status and/or identifier of a beehive. The sound processing circuitry 1022 analyzes the audio data to detect related bee sounds within the data. For example, the sound processing circuitry 1022 can analyze sounds from the beehive to determine an activity level of the bees. The activity level of the bees correlates with statuses such as an agitated bee colony, a bee colony preparing to swarm, a sick or lethargic bee colony, a bee colony with pests, or a bee colony with queen issues. In some examples, the sound processing circuitry 1022 prepares audio data to be used with training circuitry 1034 and the inference circuitry 1036 to generate an artificial intelligence model to correlate sounds with a beehive status and/or identifier. In some examples, the sound processing circuitry 1022 is instantiated by programmable circuitry executing sound processing instructions and/or configured to perform operations such as those represented by the flowcharts of FIGS. 12, 13, and/or 14.

The example location determining circuitry 1024 analyzes location data to determine a location of a beehive. In some examples, the location determining circuitry 1024 receives GPS data from the GPS circuitry 1012 to determine the location of the beehive. In other examples, the location determining circuitry 1024 uses GPS data and other sensor data (e.g., visual data from the camera circuitry 910, RFID data from the RFID circuitry 1004, audio data from the audio circuitry 1008, etc.) to correlate a location of the beehive with location data and sensor data previously stored in the database 1042. In some examples, the location of a beehive is data that is easily understood by the user (e.g., a beekeeper) to identify a location of a beehive (e.g., a street address, a name of a nearby landmark, a field number, etc.). In some examples, a location of a beehive is a user input (e.g., a text description) that is correlated with location data (e.g., GPS data from the GPS circuitry 1012) and/or sensor data (e.g., visual data from the camera circuitry 910). In some examples, the location determining circuitry 1024 uses location data to collect climate data (e.g., temperature, precipitation status, etc.) from the network (e.g., an internet weather service). In some examples, the location determining circuitry 1024 is instantiated by programmable circuitry executing location determining instructions and/or configured to perform operations such as those represented by the flowcharts of FIGS. 12, 13, and/or 14.

The example bee counting circuitry 1026 generates a number of bees present in a beehive. The bee counting circuitry 1026 analyzes sensor data (e.g., visual data received by the camera circuitry 910 and processed by the image processing circuitry 1020) to generate a number of bees present in the sensor data. In some examples, the bee counting circuitry 1026 generates an estimate of a total number of bees in the beehive. In other words, the bee counting circuitry 1026 extrapolates the number of bees in sensor data (e.g., viewable in an image) to estimate a total number of bees that may be present deeper within the beehive. In some examples, the bee counting circuitry 1026 works with the training circuitry 1034 and the inference circuitry 1036 to generate an artificial intelligence model to count bees within the visual data and generate an estimate of a total number of bees within a beehive. The bee counting circuitry 1026 stores the number of bees and/or the estimated total number of bees as status data correlated with the beehive. In some examples, the bee counting circuitry 1026 generates a number of bees corresponding to a type of bee or a role of a bee (e.g., drones, worker bees, nurse bees, etc.). In some examples, the bee counting circuitry 1026 identifies and estimates a number of bee eggs, a number of bee larvae, and/or a quantity of honey present in the beehive. In some examples, the bee counting circuitry 1026 is instantiated by programmable circuitry executing bee counting instructions and/or configured to perform operations such as those represented by the flowcharts of FIGS. 12 and/or 14.

The example queen bee identification circuitry 1028 analyzes sensor data to determine the presences of a queen bee within the beehive. In some examples, the queen bee identification circuitry 1028 analyzes image data (e.g., visual data received by the camera circuitry 910 and processed by the image processing circuitry 1020) to identify a queen bee within the image data. In other examples, the queen bee identification circuitry 1028 analyzes image data (e.g., visual data received by the camera circuitry 910 and processed by the image processing circuitry 1020) to identify bee activity correlated with serving a queen bee (e.g., worker bees feeder larvae, worker bees engaging in queen grooming behaviors) or signs of an active queen (e.g., presence of eggs, age of eggs, etc.). Relatedly, the queen bee identification circuitry 1028 analyzes sensor data for signs of a beehive with a queen bee problem (e.g., an excessive number of drone bees, an absence of a queen bee, multiple queen bees, etc.). In some examples, the queen bee identification circuitry 1028 analyzes sensor data for signs of a new queen being reared (e.g., the presence of queen cup, the presence of a queen cell, etc.). Additionally or alternatively, the queen bee identification circuitry 1028 analyzes audio data (e.g., audio data received by the audio circuitry 1008 and processed by the sound processing circuitry 1022) to identify sounds correlated with a queen bee and/or a queen bee related issue. In some examples, the queen bee identification circuitry 1028 works with the training circuitry 1034 and the inference circuitry 1036 to generate an artificial intelligence model to correlate sensor data with a queen bee status of the beehive. The queen bee identification circuitry 1028 stores the presence of a queen bee, the absence of a queen, and/or queen bee problems as status data of the beehive in the database 1042. In some examples, the queen bee identification circuitry 1028 is instantiated by programmable circuitry executing queen identification instructions and/or configured to perform operations such as those represented by the flowcharts of FIGS. 12 and/or 14.

The example beehive identification circuitry 1030 analyzes sensor data to determine an identifier of a beehive. In some examples, the identifier represents identification data easily understood by the user (e.g., a beehive name, a beehive descriptor, a beehive serial number, etc.). The identifier is used to correlate current and historic sensor data and status data with a beehive. In this way, the status of a beehive can be tracked over time via the identifier of the beehive. In some examples, the beehive identification circuitry 1030 identifies and correlates an identifier from identification data sources including one or more of RFID data received from the RFID circuitry 1004, location data received from the GPS circuitry 1012, or a QR code decoded by the camera circuitry 910. In other examples, the beehive identification circuitry 1030 works with the training circuitry 1034 and the inference circuitry 1036 to generate an artificial intelligence model to correlate sensor data with stored sensor data corresponding to a historic identifier of a beehive. In some examples, the artificial intelligence model combines location data from the GPS circuitry 1012 and sensor data from orientation sensors (e.g., magnetometers, accelerometers, gyroscopes, etc.) to differentiate beehives in close proximity and to correlate the location data and the sensor data with a historic identifier of one of the beehives. In some examples, the beehive identification circuitry 1030 determines an identifier of a beehive based on a user input. In some examples, the beehive identification circuitry 1030 is instantiated by programmable circuitry executing beehive identification instructions and/or configured to perform operations such as those represented by the flowcharts of FIGS. 12 and/or 13.

The example pest identification circuitry 1032 analyzes sensor data to determine the presences of a pest and/or disease within the beehive. In some examples, the pest identification circuitry 1032 analyzes image data (e.g., visual data received by the camera circuitry 910 and processed by the image processing circuitry 1020) to identify a pest and/or disease within the image data. In other examples, the pest identification circuitry 1032 analyzes image data (e.g., visual data received by the camera circuitry 910 and processed by the image processing circuitry 1020) to identify signs correlated with a pest and/or disease (e.g., sluggish bees, excessive number of dead bees, damage to beehive structures, etc.). Additionally or alternatively, the pest identification circuitry 1032 analyzes audio data (e.g., audio data received by the audio circuitry 1008 and processed by the sound processing circuitry 1022) to identify signs correlated with a pest and/or disease. In some examples, the pest identification circuitry 1032 works with the training circuitry 1034 and the inference circuitry 1036 to generate an artificial intelligence model to correlate sensor data with a pest and/or disease status of the beehive. The pest identification circuitry 1032 stores the presence of a pest and/or the presence of a disease as status data of the beehive in the database 1042. In some examples, the pest identification circuitry 1032 identifies a specific pest (e.g., mites, hornets, etc.) and/or a specific disease (e.g., foul brood disease). In some examples, the pest identification circuitry 1032 is instantiated by programmable circuitry executing pest identification instructions and/or configured to perform operations such as those represented by the flowcharts of FIGS. 12 and/or 14.

The example training circuitry 1034 and the example inference circuitry 1036 are used to develop artificial intelligence models to analyze sensor data and generate status data (e.g., generate a status corresponding to a beehive). Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using sensor data captured during inspections of beehives. The training circuitry 1034 uses a suitable training algorithm (e.g., stochastic gradient descent) to generate the ML/AI models. In some examples, re-training may be performed. Once training is complete, the model is deployed for use as an executable construct that processes an input and provides an output based on the network of nodes and connections defined in the model. The model is stored in the database 1042. The model may then be executed by the inference circuitry 1036.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

In some examples, the training circuitry 1034 is instantiated by programmable circuitry executing AI training instructions and/or configured to perform operations such as those represented by the flowcharts of FIG. 12, 13, and/or 14. In some examples, the inference circuitry 1036 is instantiated by programmable circuitry executing AI inference instructions and/or configured to perform operations such as those represented by the flowcharts of FIG. 12, 13, and/or 14.

The example status report circuitry 1038 generates a status report based (e.g., status summary, summary data, etc.) on status data generated by the server 106. In some examples, the status data is received as a user input (e.g., a comment). The status report includes a user readable visualization (e.g., a chart, a graph, a text summary, etc.) of data collected during an inspection of a beehive. In some examples, the status report includes a visualization (e.g., a visual representation, an image collected by the camera circuitry 910, etc.) of the inspected beehive. In some examples, the status report includes prior data stored in the database 1042 corresponding to the identification (e.g., the identifier) of the inspected beehive. In this way, the status report shows historical trends of the status of the inspected beehive. In some examples, the status report generated by the status report circuitry 1038 includes one or more of a population of bees in the beehive, a temperament of bees in the beehive, a health of a queen bee, a population of bee eggs, an age of bee eggs, a quantity of honey, a health of bees, or a presence of pests in the beehive. In some examples, the status report circuitry 1038 recognizes the presence of an adverse status (e.g., illness, the presence of pests, etc.) and generates a warning correlating to the adverse status within the status report. In some examples, the status report circuitry 1038 sends the status report to a user device (e.g., the wireless device 116 of FIG. 1, a personal computer, etc.) to be viewed by a user. In some examples, the status report circuitry 1038 is instantiated by programmable circuitry executing status report generating instructions and/or configured to perform operations such as those represented by the flowcharts of FIG. 12 and/or 14.

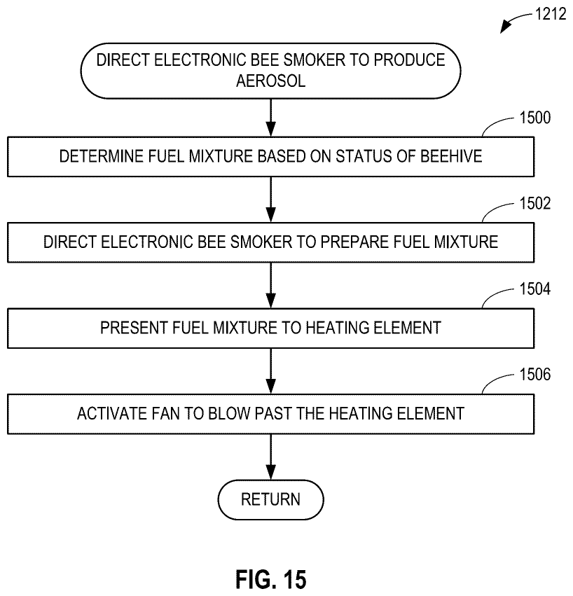

The example fuel mixture determining circuitry 1040 analyzes status data to determine a fuel mixture recipe (e.g., fuel mixture recommendation) appropriate to a status of a beehive. For example, if the fuel mixture determining circuitry 1040 receives status data indicating a healthy beehive, the fuel mixture determining circuitry 1040 will generate an example fuel mixture recipe that minimizes the cost of generating smoke. As another example, if the fuel mixture determining circuitry 1040 receives status data indicating pests within the beehive, the fuel mixture determining circuitry 1040 will generate an example fuel mixture recipe including a pest repelling additive (e.g., thyme oil). In this way, the fuel mixture determining circuitry 1040 tailors a fuel mixture recipe to alleviate an adverse status (e.g., presence of pests, presence of disease, excessive bee stress, etc.) within the beehive. The fuel mixture recipe generated by fuel mixture determining circuitry 1040 is provided to the fuel mixing circuitry 1018 so that the fuel mixture determined by the fuel mixture recipe can be generated by the electronic bee smoker 102. In some examples, the fuel mixture determining circuitry 1040 is instantiated by programmable circuitry executing fuel mixture determining instructions and/or configured to perform operations such as those represented by the flowchart of FIG. 15.

As described above, the example battery management circuitry 902, the example USB circuitry 1000, the example wireless communication circuitry 1002, the example RFID circuitry 1004, the example trigger input circuitry 1006, the example camera circuitry 910, the example audio circuitry 1008, the example temperature circuitry 1010, the example GPS circuitry 1012, the example NFC circuitry 1014, the example data filter circuitry 1016, the example fuel mixing circuitry 1018, the example image processing circuitry 1020, the example sound processing circuitry 1022, the example location determining circuitry 1024, the example bee counting circuitry 1026, the example queen bee identification circuitry 1028, the example beehive identification circuitry 1030, the example pest identification circuitry 1032, the example training circuitry 1034, the example inference circuitry 1036, the example status report circuitry 1038, and the example fuel mixture determining circuitry 1040 of FIG. 10 are structures. Such structures may implement means for performing corresponding disclosed functions. Examples of such functions are described above in connection with corresponding ones of the example battery management circuitry 902, the example USB circuitry 1000, the example wireless communication circuitry 1002, the example RFID circuitry 1004, the example trigger input circuitry 1006, the example camera circuitry 910, the example audio circuitry 1008, the example temperature circuitry 1010, the example GPS circuitry 1012, the example NFC circuitry 1014, the example data filter circuitry 1016, the example fuel mixing circuitry 1018, the example image processing circuitry 1020, the example sound processing circuitry 1022, the example location determining circuitry 1024, the example bee counting circuitry 1026, the example queen bee identification circuitry 1028, the example beehive identification circuitry 1030, the example pest identification circuitry 1032, the example training circuitry 1034, the example inference circuitry 1036, the example status report circuitry 1038, and the example fuel mixture determining circuitry 1040 are described below in connection with the flowcharts of FIGS. 11, 12, 13, 14, and/or 15.

While an example manner of implementing the electronic bee smoker 102 and/or the server 106 of FIG. 1 is illustrated in FIG. 10, one or more of the elements, processes, and/or devices illustrated in FIG. 10 may be combined, divided, re-arranged, omitted, eliminated, and/or implemented in any other way. Further, the example battery management circuitry 902, the example USB circuitry 1000, the example wireless communication circuitry 1002, the example RFID circuitry 1004, the example trigger input circuitry 1006, the example camera circuitry 910, the example audio circuitry 1008, the example temperature circuitry 1010, the example GPS circuitry 1012, the example NFC circuitry 1014, the example data filter circuitry 1016, the example fuel mixing circuitry 1018, the example image processing circuitry 1020, the example sound processing circuitry 1022, the example location determining circuitry 1024, the example bee counting circuitry 1026, the example queen bee identification circuitry 1028, the example beehive identification circuitry 1030, the example pest identification circuitry 1032, the example training circuitry 1034, the example inference circuitry 1036, the example status report circuitry 1038, and the example fuel mixture determining circuitry 1040, and/or, more generally, the example electronic bee smoker 102 and/or the server 106 of FIG. 10, may be implemented by hardware alone or by hardware in combination with software and/or firmware. Thus, for example, any of the example battery management circuitry 902, the example USB circuitry 1000, the example wireless communication circuitry 1002, the example RFID circuitry 1004, the example trigger input circuitry 1006, the example camera circuitry 910, the example audio circuitry 1008, the example temperature circuitry 1010, the example GPS circuitry 1012, the example NFC circuitry 1014, the example data filter circuitry 1016, the example fuel mixing circuitry 1018, the example image processing circuitry 1020, the example sound processing circuitry 1022, the example location determining circuitry 1024, the example bee counting circuitry 1026, the example queen bee identification circuitry 1028, the example beehive identification circuitry 1030, the example pest identification circuitry 1032, the example training circuitry 1034, the example inference circuitry 1036, the example status report circuitry 1038, and the example fuel mixture determining circuitry 1040, and/or, more generally, the example electronic bee smoker 102 and/or the server 106, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example electronic bee smoker 102 and/or the server 106 of FIG. 10 may include one or more elements, processes, and/or devices in addition to, or instead of, those illustrated in FIG. 10, and/or may include more than one of any or all of the illustrated elements, processes and devices.

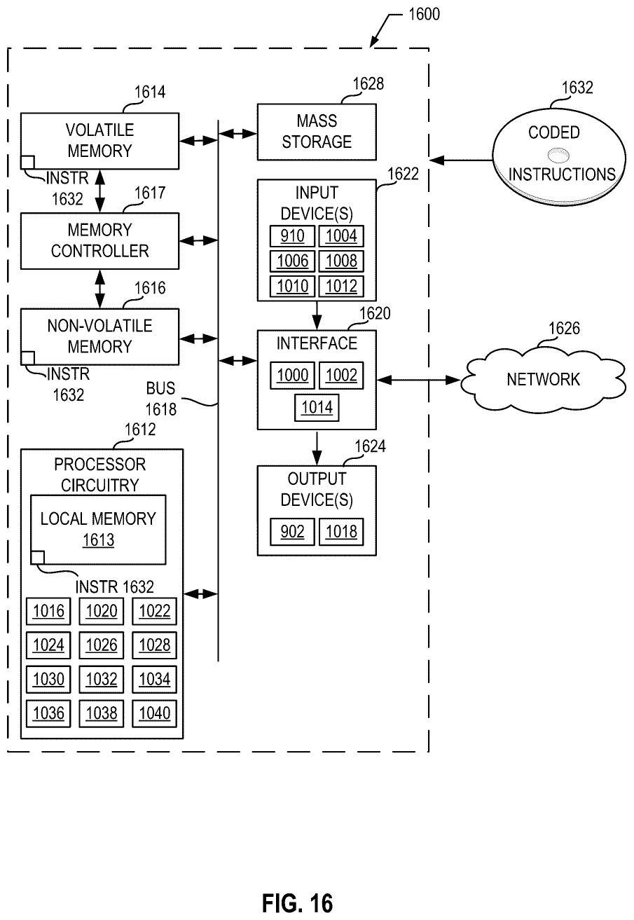

Flowcharts representative of example machine readable instructions, which may be executed by programmable circuitry to implement and/or instantiate the electronic bee smoker 102 and/or the server 106 of FIG. 10 and/or representative of example operations which may be performed by programmable circuitry to implement and/or instantiate the electronic bee smoker 102 and/or the server 106 of FIG. 10, are shown in FIGS. 12, 13, 14, and/or 15. The machine readable instructions may be one or more executable programs or portion(s) of one or more executable programs for execution by programmable circuitry such as the programmable circuitry 1612 shown in the example processor platform 1600 discussed below in connection with FIG. 16 and/or may be one or more function(s) or portion(s) of functions to be performed by other example programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 12, 13, 14, and/or 15, many other methods of implementing the example electronic bee smoker 102 and/or the server 106 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 12, 13, 14, and/or 15 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 11 is a flowchart representative of an example method 1100 to inspect beehives with an electronic bee smoker. The method 1100 of FIG. 11 begins at block 1102 with opening the beehive. Many beehive structures include a cover (e.g., the outer cover 105 of FIG. 1) to protect the bees within the beehive, which must be removed to access the beehive and inspect the contents of the beehive. The method 1100 continues to block 1104 where an electronic bee smoker (e.g., electronic bee smoker 102 of FIG. 1) is directed at the beehive. The electronic bee smoker includes sensors (e.g., the camera 802 of FIG. 8) and a nozzle (e.g., the nozzle 208 of FIGS. 2 and 8). By directing the electronic bee smoker at the beehive, this ensures that the sensors are positioned to capture sensor data from the beehive and that the nozzle is positioned to direct smoke towards the beehive. The method 1100 continues to block 1106, where the bee smoker is activated. As further detailed below in relation to FIG. 12, activating the bee smoker is accomplished by providing a user input (e.g., pulling the trigger 204 of FIG. 2). Once activated, the bee smoker will complete inspection and aerosol generation tasks as directed by example machine readable instructions and/or example operations described below in relation to FIG. 12. The method 1100 continues to block 1108, where aerosol (e.g., smoke) generated by the bee smoker is directed towards bees within the beehive. The aerosol generated by the bee smoker calms the bees, drives them deeper into the beehive, and allows for safe inspection of the beehive. The method continues to block 1109, where a sound generator (e.g., the sound generating device 702 of FIG. 7) is activated. The sound generator emits a sound that causes bees to freeze or to otherwise limit motion. In this way, the bees are encouraged to stay in place after the aerosol has been directed at the hive, further facilitating safe inspection of the beehive. The method 1100 continues to block 1110, where the beehive is inspected. In some examples, the beehive is further disassembled to view interior portions of the beehive and/or lower sections (e.g., supers, frames, etc.). In some examples, the inspection of the beehive includes harvesting or sampling honey produced by the bee colony. After the beehive is inspected, the method 1100 concludes.

FIG. 12 is a flowchart representative of example machine readable instructions and/or example operations 1106 that may be executed, instantiated, and/or performed by programmable circuitry to activate an electronic bee smoker to inspect a beehive and generate an aerosol (e.g., smoke). The example machine-readable instructions and/or the example operations 1106 of FIG. 12 begin at block 1200, at which the trigger input circuitry 1006 receives a user input. The user input is a signal received from a user action, such as depressing a trigger (e.g., the trigger 204 of FIG. 2) or receiving a signal from a user device (e.g., the wireless device 116 of FIG. 1). In some examples, the trigger input circuitry 1006 directs the battery management circuitry 902 to apply power to one or more components of the electronic bee smoker (e.g., the electronic bee smoker 102 and/or the sensor unit 800 of FIG. 8).

The operations 1106 of FIG. 12 continue to block 1202 where the electronic bee smoker receives sensor data from the sensors within the electronic bee smoker. The electronic bee smoker contains sensors (e.g., visual sensors, audio sensors, temperature sensors, RFID sensors, etc.) that collect sensor data to be stored and analyzed. Received sensor data is stored locally (e.g., within the electronic bee smoker 102 and/or sensor unit 800) and/or remotely (e.g., in the database 1042) so that it can be analyzed. In some examples, the sensor data is received by the smart smoker for analysis. In other examples, the sensor data received by a remote computing device (e.g., the server 106) for analysis. In some examples, the sensor data is filtered by the data filter circuitry 1016 before it is received by the smart smoker and/or the remote computing device. At block 1204, location data is received from location sensors (e.g., the GPS circuitry 1012). In some examples, the location data includes climate data (e.g., weather data) corresponding to the location of the beehive.

The operations 1106 of FIG. 12 continue at block 1206, where the identifier of the beehive is determined. Further detailed in relation to FIG. 13, sensor data and/or location data received from the smart bee smoker is analyzed to determine an identifier of the beehive being inspected. The identifier is used to correlate data from an inspection event with a particular beehive and historic data collected from that beehive. In this way, the electronic bee smoker automatically correlates current data with historic data without need for additional user input. In some examples, further identifiers are determined for subcomponents of the beehive (e.g., individual supers within the beehive, individual frames within the beehive, etc.).

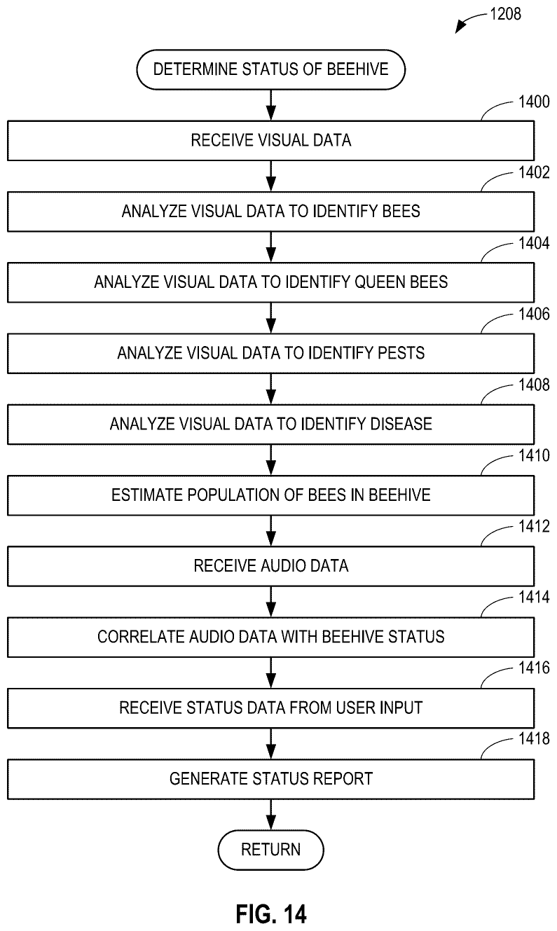

The operations 1106 of FIG. 12 continue at block 1208, where the electronic bee smoker and/or remote computing device determines a status of the beehive. As further detailed below in relation to FIG. 14, the sensor data, location data, and/or the identifier of the beehive are used to generate status data (e.g., one or more statuses relating to the location, health, population, and/or productivity of a beehive). Once the status of the beehive is determined, the operations 1106 continue to block 1210, where the sensor data, location data, identifier, and status data associated with the beehive is stored. The stored data can be used by the remote computing device (e.g., the server 106) for future analysis. In some examples the stored data is used by the status report circuitry 1038 to generate a status report. The operations 1106 conclude with block 1212, as detailed below in relation to FIG. 15, at which the electronic smoker is directed to produce aerosol (e.g., smoke).

FIG. 13 is a flowchart representative of example machine readable instructions and/or example operations 1206 that may be executed, instantiated, and/or performed by programmable circuitry to determine an identification of a beehive. The example machine-readable instructions and/or the example operations 1206 of FIG. 13 begin at block 1300, where the beehive identification circuitry 1030 receives data from previously identified beehives (e.g., historic sensor data, historic location data, historic status data, historic identifiers, etc.). In some examples, the data from previously identified beehives is retrieved from the database 1042. The operations 1206 continue to block 1302, where current RFID data generated by the RFID circuitry 1004 is compared to historic RFID. In other words, the beehive identification circuitry 1030 attempts to determine an identifier of the beehive based on an RFID tag present on or near the beehive. If the current RFID data matches the historic RFID data (e.g., the RFID tag on the beehive has been sensed previously), the operations 1206 moves to block 1312. If the current RFID data does not match the historic RFID data, the operations 1206 moves to block 1304. At block 1304, current QR code data is compared to historic QR code data. In other words, the beehive identification circuitry 1030 attempts to determine an identifier of the beehive based on QR code data generated by the camera circuitry 910 and/or the image processing circuitry 1020. If the current QR code data matches historic QR code data, the operations 1206 move to block 1312. If the current QR code data does not match historic QR code data, the operations 1206 continue to block 1306. At block 1306, current location data is compared to historic location data. In other words, the beehive identification circuitry 1030 attempts to determine an identifier of the beehive based on the current location of the beehive. If the current location data matches historic location data (e.g., the GPS data generated by the GPS circuitry 1012 is within a threshold distance of historic GPS data), the operations 1206 move to block 1312. If the current location data does not match historic location data, the operations 1306 continues to block 1308. At block 1308, current sensor data is compared to previous sensor data. In other words, the beehive identification circuitry 1030 attempts to determine an identifier of the beehive based on sensor data generated by the electronic bee smoker. In some examples, the training circuitry 1034 uses historic sensor data to generate a sensor data correlation algorithm which is used by the inference circuitry 1036 to match current sensor data to historic sensor data to determine the identifier of the beehive. In other words, sensor data such as visual data and audio data corresponding to the beehive are analyzed by the inference circuitry 1036 to determine if current sensor data are within a threshold similarity to historic sensor data. If the current sensor data matches historic sensor data, the operations 1206 move to block 1312. If the current sensor data does not match historic sensor data, the operations 1206 continue to block 1310.

At block 1310 of the example operations 1206 of FIG. 13, the beehive identification circuitry 1030 receives an identifier (e.g., identification data) from the user. In other words, the beehive identification circuitry 1030 receives an identifier from a user input when no data from the electronic bee smoker (e.g., sensor data, location data, status data, etc.) can be matched or correlated with historic data (e.g., historic sensor data, historic location data, historic status data, etc.) from a previously identified beehive. In some examples, the identifier is provided via user input after the inspection of the beehive has been completed. If data from the electronic bee smoker does match with the historic data, as described in relation to blocks 1302, 1304, 1306, and 1308, the operations 1206 continue to block 1312. At block 1312, the beehive identification circuitry 1030 receives an identifier that correlates with the matching historic data and correlates the received identifier with the current sensor data.

FIG. 14 is a flowchart representative of example machine readable instructions and/or example operations 1208 that may be executed, instantiated, and/or performed by programmable circuitry to determine a status of a beehive. The example machine-readable instructions and/or the example operations 1208 of FIG. 14 begin at block 1400, where the server 106 receives visual data generated by the camera circuitry 910 of the currently inspected beehive. In some examples, the visual data is received by the image processing circuitry 1020 to be processed (e.g., prepared for later use by other circuitry). The operations 1208 continue to block 1402, where the bee counting circuitry 1026 analyzes the visual data identify bees in the visual data. In some examples, the bee counting circuitry 1026 and the inference circuitry 1036 use an algorithm generated by the training circuitry 1034 to identify and count bees contained in the visual data. In some examples, the bee counting circuitry 1026 and/or the inference circuitry 1036 identifies bee eggs, bee larvae, and/or resources (e.g., honey, nectar, pollen, bee bread, etc.) within the comb. The operations 1208 continue to block 1404, where the queen bee identification circuitry 1028 analyzes the visual data to identify queen bees in the visual data. In some examples, the queen bee identification circuitry 1028 and the inference circuitry 1036 use an algorithm generated by the training circuitry 1034 to identify, count, and generate a status for queen bees contained in the visual data. The operations 1208 continue to block 1406, where the pest identification circuitry 1032 analyzes the visual data identify pests within the beehive. In some examples, the pest identification circuitry 1032 and the inference circuitry 1036 use an algorithm generated by the training circuitry 1034 to identify pests within the beehive. The operations 1208 continue to block 1408, where the pest identification circuitry 1032 analyzes the visual data for visible signs of disease in the bees. In some examples, the pest identification circuitry 1032 and the inference circuitry 1036 use an algorithm generated by the training circuitry 1034 to identify signs of disease within the beehive. The operations 1208 continue to 1410, where the bee counting circuitry 1026 estimates a total population of bees in the beehive. In some examples, the bee counting circuitry 1026 identifies and counts bees in image data and generates a total population of bees by summing bees counted across the image data that correlate to the structures in the hive (e.g., frames, supers, brood boxes, etc.). In other examples, the total population of bees is estimated from the number of bees found in visual data (e.g., a picture of the beehive) that represents a portion of the total population of bees. In other words, the bee counting circuitry 1026 estimates a total population of bees, including bees that may be outside of the beehive or otherwise hidden from view, based on a count of bees present in the visual data. In some examples, the bee counting circuitry 1026 and the inference circuitry 1036 use an algorithm generated by the training circuitry 1034 to estimate the population of bees. In some examples, the bee counting circuitry 1026 estimates an estimate of total bee eggs, bee larvae, and/or honey within the beehive. The operations 1208 continue to block 1412, where the server 106 receives audio data generated by the audio circuitry 1008 of the currently inspected beehive. In some examples, the audio data is received by the sound processing circuitry 1022 to be processed (e.g., prepared for later use by other circuitry). The operations 1208 continue to block 1414, where the sound processing circuitry 1022 and/or the inference circuitry 1036 correlate the received audio data with one or more beehive status (e.g., the sound of a beehive that is ready to swarm, the sound of a calm beehive, the sound of a stressed beehive, etc.). The operations 1208 continue to block 1416, where the status report circuitry 1038 receives status data from a user input. In some examples, the status data received from the user input is text including observations and/or notes from the user. In some examples, the user inputs status data after the inspection has been completed. The operations 1208 conclude with block 1418, where the status report circuitry 1038 generates a status report based on analyzed sensor data. The status report includes status data pertaining to the status of the beehive, such as a population of bees in the beehive, a temperament of bees in the beehive, a health of a queen bee, a population of bee eggs, a quantity of honey, a health of bees, and/or a presence of pests in the beehive. Once the operations 1208 are completed, the operations return to block 1210 as discussed above in relation to FIG. 12.

FIG. 15 is a flowchart representative of example machine readable instructions and/or example operations 1212 that may be executed, instantiated, and/or performed by programmable circuitry to direct an electronic bee smoker to produce aerosol. The example machine-readable instructions and/or the example operations 1212 of FIG. 15 begin at block 1500, where the fuel mixture determining circuitry 1040 determines a fuel mixture based on the status of the beehive. A fuel mixture is a mixture of fuels and/or additives that are selected to correspond with one or more status of the beehive. Once a fuel mixture is determined, the operations 1212 continue to block 1502 where the fuel mixing circuitry 1018 directs the electronic bee smoker to prepare the fuel mixer. The fuel mixing circuitry 1018 directs the fuel mixing pumps to generate the fuel mixture determined by the fuel mixture determining circuitry 1040. The operations 1212 continue to block 1504, where the fuel mixture is presented from a mixing chamber to the heating element of the electronic bee smoker. When the fuel mixture is presented to the heating element (e.g., the heating element 304 of FIGS. 3A and 3B), the fuel mixture is heated and turned into an aerosol. The operations 1212 conclude block 1506, where the battery management circuitry 902 activates the fan to move air past the heating element. The air moving past the heating element moves the aerosol in an air jet, allowing the aerosol to be directed towards a target.

FIG. 16 is a block diagram of an example programmable circuitry platform 1600 structured to execute and/or instantiate the example machine-readable instructions and/or the example operations of FIGS. 12, 13, 14, and/or 15 to implement the electronic bee smoker 102 and/or the server 106 of FIG. 10. The programmable circuitry platform 1600 can be, for example, a server, a personal computer, a workstation, a self-learning machine (e.g., a neural network), a mobile device (e.g., a cell phone, a smart phone, a tablet such as an iPad™M), a personal digital assistant (PDA), an Internet appliance, a digital video recorder, a personal video recorder, a headset (e.g., an augmented reality (AR) headset, a virtual reality (VR) headset, etc.) or other wearable device, or any other type of computing and/or electronic device.

The programmable circuitry platform 1600 of the illustrated example includes programmable circuitry 1612. The programmable circuitry 1612 of the illustrated example is hardware. For example, the programmable circuitry 1612 can be implemented by one or more integrated circuits, logic circuits, FPGAs, microprocessors, CPUs, GPUs, DSPs, and/or microcontrollers from any desired family or manufacturer. The programmable circuitry 1612 may be implemented by one or more semiconductor based (e.g., silicon based) devices. In this example, the programmable circuitry 1612 implements the example battery management circuitry 902, the example camera circuitry 910, the example USB circuitry 1000, the example wireless communication circuitry 1002, the example RFID circuitry 1004, the example trigger input circuitry 1006, the example audio circuitry 1008, the example temperature circuitry 1010, the example GPS circuitry 1012, the example NFC circuitry 1014, the example data filter circuitry 1016, the example fuel mixing circuitry 1018, the example image processing circuitry 1020, the example sound processing circuitry 1022, the example location determining circuitry 1024, the example bee counting circuitry 1026, the example queen bee identification circuitry 1028, the example beehive identification circuitry 1030, the example pest identification circuitry 1032, the example training circuitry 1034, the example inference circuitry 1036, the example status report circuitry 1038, and the example fuel mixture determining circuitry 1040.

The programmable circuitry 1612 of the illustrated example includes a local memory 1613 (e.g., a cache, registers, etc.). The programmable circuitry 1612 of the illustrated example is in communication with main memory 1614, 1616, which includes a volatile memory 1614 and a non-volatile memory 1616, by a bus 1618. The volatile memory 1614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1616 may be implemented by flash memory and/or any other desired type of memory device. Access to the main memory 1614, 1616 of the illustrated example is controlled by a memory controller 1617. In some examples, the memory controller 1617 may be implemented by one or more integrated circuits, logic circuits, microcontrollers from any desired family or manufacturer, or any other type of circuitry to manage the flow of data going to and from the main memory 1614, 1616.

The programmable circuitry platform 1600 of the illustrated example also includes interface circuitry 1620. The interface circuitry 1620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1622 are connected to the interface circuitry 1620. The input device(s) 1622 permit(s) a user (e.g., a human user, a machine user, etc.) to enter data and/or commands into the programmable circuitry 1612. The input device(s) 1622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1624 are also connected to the interface circuitry 1620 of the illustrated example. The output device(s) 1624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1620 of the illustrated example, thus, typically includes a graphics driver card, a graphics driver chip, and/or graphics processor circuitry such as a GPU.

The interface circuitry 1620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1600 of the illustrated example also includes one or more mass storage discs or devices 1628 to store firmware, software, and/or data. Examples of such mass storage discs or devices 1628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1632, which may be implemented by the machine readable instructions of FIGS. 12, 13, 14, and/or 15, may be stored in the mass storage device 1628, in the volatile memory 1614, in the non-volatile memory 1616, and/or on at least one non-transitory computer readable storage medium such as a CD or DVD which may be removable.

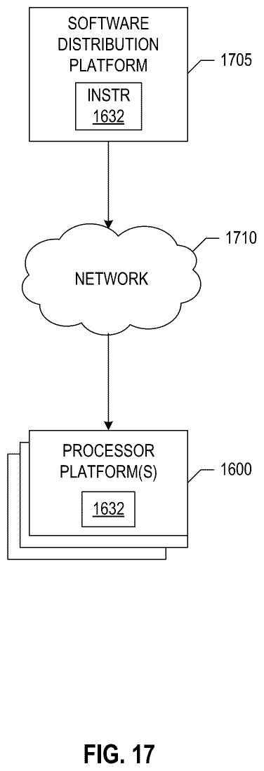

A block diagram illustrating an example software distribution platform 1705 to distribute software such as the example machine readable instructions 1632 of FIG. 16 to other hardware devices (e.g., hardware devices owned and/or operated by third parties from the owner and/or operator of the software distribution platform) is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine readable instructions 1632 of FIG. 16. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine readable instructions 1632, which may correspond to the example machine readable instructions of FIGS. 12, 13, 14, and/or 15, as described above. The one or more servers of the example software distribution platform 1705 are in communication with an example network 1710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1632 from the software distribution platform 1705. For example, the software, which may correspond to the example machine readable instructions of FIG. 12, 13, 14, and/or 15, may be downloaded to the example programmable circuitry platform 1600, which is to execute the machine readable instructions 1632 to implement the electronic bee smoker 102 and/or the server 106. In some examples, one or more servers of the software distribution platform 1705 periodically offer, transmit, and/or force updates to the software (e.g., the example machine readable instructions 1632 of FIG. 16) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that improve the process of inspecting beehives. Example electronic bee smokers disclosed herein allow beekeepers to produce smoke or other aerosols on demand, without needing to start or maintain a fire. Example electronic bee smokers described herein are safer than known bee smokers due to lower working temperatures. Example electronic bee smokers described herein can be easily carried, stowed, and accessed during inspection of beehives, allowing a beekeeper to direct smoke at bees during any stage of the inspection. Example electronic bee smokers described herein collect data using sensors during inspection without requiring additional or alternative equipment to be directed at the beehive. Example electronic bee smokers described herein communicate with computing devices to analyze sensor data to determine a status of a beehive being inspected, speeding up the inspection process. Example computing devices disclosed herein analyze sensor data from an electronic bee smoker to generate a status report for the beehive and alert a beekeeper of any potential issues that may be present in the beehive. Example computing devices disclosed herein analyze sensor data from an electronic bee smoker to identify and track a beehive status over time, allowing beekeepers to review the health and productivity of a beehive even if the beehive moves to different sites over a period of time. Example electronic bee smokers described herein communicate with computing devices to analyze sensor data to determine a status of a beehive and provide a smoke generating fuel mixture in response to any adverse beehive status found in the sensor data. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to inspect a beehive using an electronic bee smoker are disclosed herein. Further examples and combinations thereof include the following:

Example 1 includes a hand-held apparatus for generating a stream of smoke, comprising a hand grip including an activation switch, the activation switch to initiate production of smoke, a vessel to contain smoke generating materials, a heating element to receive the smoke generating materials from the vessel, a fan to move air past the heating element, the air to move in a direction away from the hand grip, and a battery to provide power to the fan and the heating element.

Example 2 includes the apparatus of example 1, wherein the vessel is removably coupled to the apparatus.

Example 3 includes the apparatus of example 2, wherein the vessel is coupled to the apparatus using a permanent magnet.

Example 4 includes the apparatus of example 1, further including a power conditioner to change an amount of power provided to the heating element.

Example 5 includes the apparatus of example 1, wherein the activation switch is positioned to be finger operated while the apparatus is held by the hand grip and the activation switch is a momentary switch.

Example 6 includes the apparatus of example 1, further including a potentiometer, the potentiometer to vary a rotational speed of the fan based on a user input.

Example 7 includes the apparatus of example 1, wherein the smoke generating materials are at least one of a liquid, a wax, or an organic material.

Example 8 includes the apparatus of example 1, wherein the heating element is disposed in the vessel.

Example 9 includes the apparatus of example 1, wherein the vessel includes an opening to accept air from the fan and direct it towards the heating element.

Example 10 includes the apparatus of example 1, further including a body, the body having a first end and a second end opposite the first end, the body to house the fan and the heating element, the first end and the second end configured to allow air to enter the first end and exit the second end and the hand grip coupled to the first end of the body.

Example 11 includes the apparatus of example 10, wherein the heating element is disposed at the second end of the body.

Example 12 includes the apparatus of example 1, wherein the vessel is a plurality of vessels, and the apparatus further includes a mixing chamber, the mixing chamber to receive smoke generating materials contained in the vessels to be presented to the heating element.

Example 13 includes the apparatus of example 1, further including a light emitting diode (LED).

Example 14 includes the apparatus of example 13, wherein the LED produces at least one of white light, red light, or ultraviolet light.

Example 15 includes an apparatus for generating an aerosol jet, the apparatus comprising an aerosol generator including a substance to produce an aerosol, an airflow generator to move the aerosol generated by the aerosol generator in an air jet, a nozzle to guide the air jet, a power source to provide power to the airflow generator and the aerosol generator, and a housing to at least partially contain the aerosol generator, the airflow generator, the nozzle, and the power source.

Example 16 includes the apparatus of example 15, wherein the housing includes a handle and a trigger disposed on the handle, the trigger to be actuated by a finger while the handle is being held, the trigger to activate the airflow generator and the aerosol generator.

Example 17 includes the apparatus of example 16, wherein the handle is rotatably coupled to the housing, the handle to rotate at least between a stowed position, an edge of the handle to rest along the housing while in the stowed position, a first position substantially perpendicular to the nozzle, and a second position, the edge of the handle to extend away from the housing in a substantially parallel direction while in the second position.

Example 18 includes the apparatus of example 17, wherein the trigger is to be exposed in the first and second positions and hidden in the stowed position.

Example 19 includes the apparatus of example 15, wherein the aerosol generator is disposed in the nozzle.

Example 20 includes the apparatus of example 15, further including a mounting system disposed on the housing, the mounting system removably coupled to the housing, the mounting system to couple to a beekeeper to hold the apparatus when not in use.

Example 21 includes the apparatus of example 20, wherein the mounting system includes a receiving portion that includes at least one of a permanent magnet or a ferromagnetic material and fixing portion that includes at least one of a permanent magnet or a ferromagnetic material, the fixing portion permanently coupled to the housing.

Example 22 includes the apparatus of example 21, wherein the fixing portion is a first fixing portion, and the housing includes a second fixing portion, the second fixing portion positioned separate from the first fixing portion, the receiving portion to be selectively coupled to the first fixing portion or the second fixing portion.

Example 23 includes the apparatus of example 21, wherein the permanent magnet and the ferromagnetic material are arranged to orient the apparatus relative to the beekeeper when the housing is coupled to the mounting system and the mounting system is coupled to the beekeeper.

Example 24 includes the apparatus of example 20, wherein the mounting system includes a clip, the clip to couple to an article of clothing on the beekeeper.

Example 25 includes the apparatus of example 15, further including a sound generating device and a switch, the switch to activate the sound generating device.

Example 26 includes the apparatus of example 25, wherein the sound generating device generates ultrasonic sounds to repel bees.

Example 27 includes the apparatus of example 25, wherein the sound generating device generates a sound to immobilize bees.

Example 28 includes an apparatus for inspecting beehives, comprising a housing including a mounting location disposed on an exterior surface of the housing, the mounting location structured to removably couple the housing to a beekeeping tool, an electrical contact disposed at the mounting location, the electrical contact to receive an electrical signal from the beekeeping tool, sensors at least partially disposed in the housing including at least a microphone, a digital camera, and a global positioning system (GPS) receiver, and a controller including at least one memory and disposed in the housing, the controller in communication with the sensors and the electrical contact, the controller to obtain data from the sensors based on receiving the electrical signal from the electrical contact.

Example 29 includes the apparatus of example 28, wherein the sensors include a temperature sensor.

Example 30 includes the apparatus of example 28, further including a rechargeable battery and battery management circuitry to at least charge the battery.

Example 31 includes the apparatus of example 28, wherein the controller further includes communication circuitry to send the data to an external device.

Example 32 includes the apparatus of example 31, wherein the communication circuitry is wireless communication circuitry.

Example 33 includes the apparatus of example 28, wherein the sensors include a radio-frequency identification (RFID) reader to receive beehive identification data.

Example 34 includes the apparatus of example 28, wherein the electrical signal is a plurality of momentary electrical signals, and the controller records data based on receiving a threshold number of electrical signals within a threshold amount of time.

Example 35 includes the apparatus of example 28, wherein the digital camera is coupled to the housing on a front surface of the housing such that a lens of the digital camera collects images towards a working end of a beekeeping tool when the housing is coupled to the beekeeping tool.

Example 36 includes the apparatus of example 28, further including a switch coupled to a side surface of the housing, the switch to send a signal to the controller.

Example 37 includes the apparatus of example 36, wherein the signal is a power signal to apply power to the controller and the sensors.

Example 38 includes the apparatus of example 36, wherein the signal instructs the controller to capture data from the sensors.

Example 39 includes the apparatus of example 28, wherein the beekeeping tool is at least one of a bee smoker, a glove, a hat, or a beekeeping suit.

Example 40 includes an apparatus for generating an aerosol jet and inspecting beehives, comprising an aerosol generator including a fluid to produce an aerosol, an airflow generator to move the aerosol in an air jet, a nozzle to guide the air jet, a voltage source to provide a voltage to the airflow generator and the aerosol generator, a first housing portion to at least partially house the aerosol generator, the airflow generator, the nozzle, and the voltage source, a camera to capture images in a direction parallel to the nozzle, a microphone, a GPS receiver, a controller with at least one memory in communication with the camera, the microphone, and the GPS receiver, and a second housing portion to at least partially contain the controller, the camera, the microphone, and the GPS receiver, the second housing portion coupled to the first housing portion.

Example 41 includes the apparatus of example 40, wherein the second housing portion is detachably coupled to the first housing portion.

Example 42 includes the apparatus of example 40, further including a trigger disposed in the first housing portion, the trigger to receive a user input from a finger.

Example 43 includes the apparatus of example 42, further including an electrical interface between the first housing portion and the second housing portion, the electrical interface to convey a signal from the trigger to the controller.

Example 44 includes the apparatus of example 43, wherein the controller captures data from the camera, the microphone, and the GPS receiver based on receiving the signal from the trigger.

Example 45 includes the apparatus of example 40, further including a temperature sensor in communication with the controller.

Example 46 includes the apparatus of example 40, further including a radio-frequency identification (RFID) reader in communication with the controller.

Example 47 includes the apparatus of example 40, wherein the controller includes communication circuitry.

Example 48 includes the apparatus of example 47, wherein the communication circuitry includes wireless communication circuitry.

Example 49 includes a method for inspecting a beehive using an electronic bee smoker, the method comprising opening the beehive, directing the electronic bee smoker at the beehive, the bee smoker including a grip including a trigger, the trigger to activate the electronic bee smoker, an aerosol generator including a fluid to produce an aerosol, an airflow generator to move the aerosol in an air jet, a nozzle to guide the air jet, a power source to provide power to the airflow generator and the aerosol generator, sensors including at least a camera to capture images of at least a portion of the beehive, a microphone, and a GPS receiver, and a controller with at least one memory in communication with the sensors, activating the bee smoker, the bee smoker to at least collect data from the sensors, store the data, and direct the bee smoker to generate aerosol, directing the aerosol generated by the bee smoker towards bees, and inspecting the beehive.

Example 50 includes the method of example 49, wherein activating the bee smoker further includes identifying the beehive based on the data.

Example 51 includes the method of example 50, wherein identifying the beehive includes receiving quick-response code (QR code) data from the camera.

Example 52 includes the method of example 50, wherein the sensors include radio-frequency identification (RFID) reader, and the beehive is identified based on RFID data.

Example 53 includes the method of example 49, wherein activating the bee smoker further includes determining a status of the beehive based on the data.

Example 54 includes the method of example 49, wherein the controller includes communication circuitry and data is stored remote from the controller.

Example 55 includes the method of example 49, wherein the electronic bee smoker includes a light emitting diode (LED) to emit light in a direction toward the beehive.

Example 56 includes the method of example 55, wherein the LED emits ultraviolet light to induce fluorescence in bee eggs and larvae.

Example 57 includes the method of example 49, further including activating a sound generating device to immobilize bees.

Example 58 includes an apparatus to monitor a beehive comprising interface circuitry, machine readable instructions, and programmable circuitry to at least one of instantiate or execute the machine readable instructions to receive sensor data associated with the beehive, receive location data corresponding to the beehive, determine identification data of the beehive, determine a status of the beehive based on the sensor data, store the sensor data, the location data, the identification data, and the status of the beehive as inspection data associated with the beehive, and display at least part of the inspection data.

Example 59 includes the apparatus of example 58, wherein the programmable circuitry further determines a smoke fluid mixture for a bee smoker based on the status of the beehive.

Example 60 includes the apparatus of example 59, wherein the programmable circuitry further directs the bee smoker to produce smoke using the smoke fluid mixture.

Example 61 includes the apparatus of example 58, wherein the sensor data includes at least camera data, audio data, and temperature data.

Example 62 includes the apparatus of example 61, wherein the identification data includes quick-response code (QR code) data derived from the camera data.

Example 63 includes the apparatus of example 58, wherein the location data includes global positioning system (GPS) data.

Example 64 includes the apparatus of example 58, wherein the location data includes time data and date data.

Example 65 includes the apparatus of example 64, wherein the location data includes weather data corresponding to a location of the beehive, the time data, and the date data.

Example 66 includes the apparatus of example 58, wherein the sensor data includes radio-frequency identification (RFID) data, and the identification data is determined at least in part by RFID data.

Example 67 includes the apparatus of example 58, wherein the identification data is received from a user input.

Example 68 includes the apparatus of example 58, wherein the identification data is determined by correlating at least one of the location data or the sensor data with identification data from a previously identified beehive.

Example 69 includes the apparatus of example 58, wherein the status is determined at least in part by a user input.

Example 70 includes the apparatus of example 58, wherein the status of the beehive includes at least one of a population of bees in the beehive, a temperament of bees in the beehive, a health of a queen bee, a population of bee eggs, a quantity of honey, a health of bees, or a presence of pests in the beehive.

Example 71 includes the apparatus of example 70, wherein the status is determined based on sensor data analyzed by a machine learning algorithm.

Example 72 includes the apparatus of example 58, wherein the programmable circuitry further filters the sensor data before being stored.

Example 73 includes the apparatus of example 72, wherein filtering the sensor data includes removing data that does not include bees or a beehive.

Example 74 includes the apparatus of example 58, wherein the inspection data is stored in a server.

Example 75 includes a non-transitory machine readable storage medium comprising instructions to cause programmable circuitry to at least receive sensor data associated with a beehive, receive location data corresponding to the beehive, determine an identifier of the beehive, determine a status of the beehive based on the sensor data, store the sensor data, the location data, the identifier, and the status data, and generate summary data corresponding to the identifier, the summary data including at least part of at least one of the sensor data, the location data, or the status data.

Example 76 includes the non-transitory machine readable storage medium of example 75, wherein the instructions cause the programmable circuitry to display summary data corresponding to the identifier of the beehive.

Example 77 includes the non-transitory machine readable storage medium of example 76, wherein the instructions to determine a status of the beehive include instructions to determine if an adverse status is present and instructions to display the summary data include instructions to display a warning correlating to the adverse status.

Example 78 includes the non-transitory machine readable storage medium of example 75, wherein the identifier is at least one of a name or serial number.

Example 79 includes the non-transitory machine readable storage medium of example 75, wherein instructions to determine the identifier of the beehive includes receive stored identifiers, receive stored sensor data corresponding to the stored identifiers, receive stored location data corresponding to the stored identifiers, correlate at least one of the sensor data or the location data with the stored sensor data or the stored location data corresponding to a stored identifier, and determine the identifier based on the corresponding stored identifier.

Example 80 includes the non-transitory machine readable storage medium of example 75, wherein at least one of the identifier or the status data is based on a user input.

Example 81 includes the non-transitory machine readable storage medium of example 75, wherein the sensor data includes image data received from a camera and the instructions to determine a status of the beehive based on the sensor data include analyze the image data to identify bees, queen bees, and visible signs of disease, estimate a total number of the bees and the queen bees in the beehive based on the analyzed image data, and store the estimated number of bees, the estimated number of queen bees, and the visible signs of disease as status data.

Example 82 includes the non-transitory machine readable storage medium of example 75, wherein the sensor data includes audio data received from a microphone and the instructions to determine a status of the beehive based on the sensor data include analyze the audio data for bee sounds, correlate the bee sounds with a beehive status, and store the beehive status as status data.

Example 83 includes the non-transitory machine readable storage medium of example 75, wherein the instructions cause the programmable circuitry to determine a smoker fuel mixture based on the status of the beehive, the smoker fuel mixture including one or more aerosol generating compounds, generate a recommendation based on the smoker fuel mixture, and communicate the recommendation to an electronic bee smoker.

Example 84 includes the non-transitory machine readable storage medium of example 75, wherein the beehive includes a plurality of frames, one or more frames having corresponding sensor data, location data, identifier, and status data associated with the one or more frames, and the summary data includes data corresponding to the one or more frames.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A hand-held apparatus for generating a stream of smoke, comprising:
a hand grip including an activation switch, the activation switch to initiate production of smoke;
a nozzle;
a vessel to contain smoke generating materials;
a heating element to receive the smoke generating materials from the vessel;
a fan to move air past the heating element, the air to move in a direction away from the hand grip to exit the nozzle; and
a battery to provide power to the fan and the heating element.

2. The apparatus of claim 1, wherein the vessel is removably coupled to the apparatus.

3. (canceled)

4. (canceled)

5. The apparatus of claim 1, wherein the activation switch is positioned to be finger operated while the apparatus is held by the hand grip and the activation switch is a momentary switch.

6. (canceled)

7. The apparatus of claim 1, wherein the smoke generating materials are at least one of a liquid, a wax, or an organic material.

8. The apparatus of claim 2, wherein the heating element is disposed in the vessel.

9. (canceled)

10. The apparatus of claim 1, further including a body, the body having a first end and a second end opposite the first end, the body to house the fan and the heating element, the first end and the second end configured to allow air to enter the first end and exit the second end and the hand grip coupled to the first end of the body.

11-14. (canceled)

15. An apparatus for generating an aerosol jet, the apparatus comprising:
an aerosol generator including a substance to produce an aerosol;
an airflow generator to move the aerosol generated by the aerosol generator in an air jet;
a controller configured to at least one of control the apparatus or collect data associated with a beehive;
a power source to provide power to the airflow generator, the aerosol generator and the controller; and
a housing to at least partially contain the aerosol generator, the airflow generator, and the power source.

16. The apparatus of claim 15, wherein the housing includes a handle and a trigger disposed on the handle, the trigger to be actuated by a finger while the handle is being held, the trigger to activate the airflow generator and the aerosol generator.

17. The apparatus of claim 16, wherein the handle is rotatably coupled to the housing, the handle to rotate at least between:
a stowed position, an edge of the handle to rest along the housing while in the stowed position;
a first position substantially perpendicular to a direction of the air jet; and
a second position, the edge of the handle to extend away from the housing in a substantially parallel direction while in the second position.

18. (canceled)

19. The apparatus of claim 15, wherein the aerosol generator is adjacent a nozzle of the housing.

20. The apparatus of claim 15, further including a mounting system disposed on the housing, the mounting system removably coupled to the housing, the mounting system to couple to a beekeeper to hold the apparatus when not in use.

21. The apparatus of claim 20, wherein the mounting system includes a receiving portion that includes at least one of a permanent magnet or a ferromagnetic material and a fixing portion that includes at least one of a permanent magnet or a ferromagnetic material, the fixing portion permanently coupled to the housing.

22. (canceled)

23. The apparatus of claim 21, wherein the mounting system is configured to orient the apparatus relative to the beekeeper when the housing is coupled to the mounting system and the mounting system is coupled to the beekeeper.

24. The apparatus of claim 20, wherein the mounting system includes a clip, the clip to couple to an article of clothing on the beekeeper.

25. The apparatus of claim 15, further including a vibration generating device and a switch, the switch to activate the vibration generating device.

26. (canceled)

27. The apparatus of claim 25, wherein the vibration generating device generates a vibration to affect bees.

28-39. (canceled)

40. An apparatus for generating an aerosol jet and inspecting beehives, comprising:
an aerosol generator including a fluid to produce an aerosol;
an airflow generator to move the aerosol in an air jet;
at least one sensor;
a controller with at least one memory in communication with the at least one sensor; and
a voltage source to supply voltage to the airflow generator, the aerosol generator and the controller.

41. The apparatus of claim 40, further including a housing including a hand grip.

42. The apparatus of claim 40, further including a trigger disposed on the hand grip.

43. The apparatus of claim 42, further including an electrical interface to convey a signal from the trigger to the controller.

44. The apparatus of claim 43, wherein the controller captures data from a camera, a microphone, or a GPS receiver based on receiving the signal from the trigger.

45. (canceled)

46. The apparatus of claim 40, further including a radio-frequency identification (RFID) reader in communication with the controller.

47. The apparatus of claim 40, wherein the controller includes communication circuitry.

48-84. (canceled)

85. The apparatus of claim 1, further in including a potentiometer to vary a rotational speed of the fan based on a user input.

86. The apparatus of claim 1, wherein the vessel includes an opening to accept air from the fan and direct it towards the heating element.

87. The apparatus of claim 10, wherein the body includes a battery compartment including a removable portion.
